(19) United States
(12) Patent Application Publication
(10) Pub. No.: US 2026/0155972 A1
(43) Pub. Date: Jun. 4, 2026

(54) LOST AND FOUND SERVICE FOR RADIO FREQUENCY IDENTIFICATION (RFID) TAGS

(71) Applicant: QUALCOMM Incorporated, San Deigo, CA (US)

(72) Inventors: Soo Bum LEE, San Diego, CA (US); Joseph Patrick BURKE, Carlsbad, CA (US); Gavin Bernard HORN, La Jolla, CA (US)

(21) Appl. No.: 18/969,140

(22) Filed: Dec. 4, 2024

(51) Int. Cl. H04L 9/14; G06K 19/07

(52) U.S. Cl. CPC H04L 9/14; G06K 19/0709

(57) ABSTRACT

Systems and techniques are described for wireless communications. For example, a processing system of a device (e.g., a passive device) can generate private information (e.g., associated with the device and/or an item associated with the device) based on application of a cryptographic algorithm to information using a secret key. The processing system can receive, from a reader device, an energizing signal and can transmit (or output for transmission), based on the energizing signal, a backscatter signal including the private information to the reader device. A network device can register, with a server, the private information and a public key associated with the secret key. The network device can receive, from the server, an encrypted location of a reader device, can decrypt, based on the secret key, the encrypted location to determine a location of the reader device, and can determine an estimated location of the item based on the location.

### FIELD

The present disclosure generally relates to wireless communications. For example, aspects of the present disclosure relate to a lost and found service for radio frequency identification (RFID) tags.

### BACKGROUND

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Systems and techniques are described for wireless communications. In some aspects, an apparatus for wireless communications is provided. The apparatus includes a processing system configured to: generate private information based on application of a cryptographic algorithm to information using a secret key, wherein the information is associated with the apparatus and with an item associated with the apparatus; receive, from a reader device, an energizing signal; and output, based on receiving the energizing signal, a backscatter signal for transmission to the reader device, wherein the backscatter signal includes the private information.

In some aspects, a method for wireless communications performed at a passive device is provided. The method includes: generating private information based on applying a cryptographic algorithm to information using a secret key, wherein the information is associated with the passive device and with an item associated with the passive device; receiving, from a reader device, an energizing signal; and transmitting, based on receiving the energizing signal, a backscatter signal to the reader device, wherein the backscatter signal includes the private information.

In some aspects, a non-transitory computer-readable medium of an apparatus is provided having stored thereon instructions that, when executed by at least one processor, cause the at least one processor to: generate private information based on application of a cryptographic algorithm to information using a secret key, wherein the information is associated with the apparatus and with an item associated with the apparatus; receive, from a reader device, an energizing signal; and output, based on receiving the energizing signal, a backscatter signal for transmission to the reader device, wherein the backscatter signal includes the private information.

In some aspects, an apparatus for wireless communications is provided. The apparatus includes: means for generating private information based on applying a cryptographic algorithm to information using a secret key, wherein the information is associated with the apparatus and with an item associated with the apparatus; means for receiving, from a reader device, an energizing signal; and means for transmitting, based on receiving the energizing signal, a backscatter signal to the reader device, wherein the backscatter signal includes the private information.

In some aspects, a network device for wireless communications is provided. The network device includes a processing system configured to: register, with a server, private information and a public key associated with a secret key, wherein the private information is generated by a passive device applying a cryptographic algorithm to information using the secret key, and wherein the information is associated with the passive device and with an item associated with the passive device; receive, from the server, an encrypted location of a reader device, wherein the encrypted location is associated with a backscatter signal from the passive device generated based on the reader device energizing the passive device; decrypt, based on the secret key, the encrypted location to determine a location of the reader device; and determine, based on the location of the reader device, an estimated location of the item.

In some aspects, a method for wireless communications performed at a network device is provided. The method includes: registering, with a server, private information and a public key associated with a secret key, wherein the private information is generated by a passive device applying a cryptographic algorithm to information using the secret key, and wherein the information is associated with the passive device and with an item associated with the passive device; receiving, from the server, an encrypted location of a reader device, wherein the encrypted location is associated with a backscatter signal from the passive device generated based on the reader device energizing the passive device; decrypting, based on the secret key, the encrypted location to determine a location of the reader device; and determining, based on the location of the reader device, an estimated location of the item.

In some aspects, a non-transitory computer-readable medium of a network device is provided having stored thereon instructions that, when executed by at least one processor, cause the at least one processor to: register, with a server, private information and a public key associated with a secret key, wherein the private information is generated by a passive device applying a cryptographic algorithm to information using the secret key, and wherein the information is associated with the passive device and with an item associated with the passive device; receive, from the server, an encrypted location of a reader device, wherein the encrypted location is associated with a backscatter signal from the passive device generated based on the reader device energizing the passive device; decrypt, based on the secret key, the encrypted location to determine a location of the reader device; and determine, based on the location of the reader device, an estimated location of the item.

In some aspects, an apparatus for wireless communications is provided. The apparatus includes: means for registering, with a server, private information and a public key associated with a secret key, wherein the private information is generated by a passive device applying a cryptographic algorithm to information using the secret key, and wherein the information is associated with the passive device and with an item associated with the passive device; means for receiving, from the server, an encrypted location of a reader device, wherein the encrypted location is associated with a backscatter signal from the passive device generated based on the reader device energizing the passive device; means for decrypting, based on the secret key, the encrypted location to determine a location of the reader device; and means for determining, based on the location of the reader device, an estimated location of the item.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating components of a user equipment (UE), in accordance with some aspects of the disclosure.

FIG. 2 is a diagram illustrating an example of a radio frequency (RF) energy harvesting device, in accordance with some aspects of the disclosure.

FIG. 3 is a diagram illustrating an example of small signal operation of a Schottky diode barrier, in accordance with some aspects of the disclosure.

FIG. 4A is a diagram illustrating example energy harvesting characteristics between input power and harvested power, in accordance with some aspects of the disclosure.

FIG. 4B is a diagram illustrating an example of energy conversion efficiency associated with different frequencies and input powers, in accordance with some aspects of the disclosure.

FIG. 5 is a diagram of an example of a system for tracking items associated with passive devices, in accordance with some aspects of the disclosure.

FIG. 6 is a diagram of an example of a system for a lost and found service for locating a lost item associated with a passive device, in accordance with some aspects of the disclosure.

FIG. 7 is a flow diagram illustrating an example of a process for wireless communications at a passive device, in accordance with some aspects of the disclosure.

FIG. 8 is a flow diagram illustrating an example of a process for wireless communications at a network device, in accordance with some aspects of the disclosure.

FIG. 9 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Wireless communication networks can be deployed to provide various communication services, such as voice, video, packet data, messaging, broadcast, any combination thereof, or other communication services. A wireless communication network may support both access links and sidelinks for communication between wireless devices.

In wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc. In some aspects, passive IoT devices may also be referred to as “ambient IoT devices” or simply as “passive devices”. For example, a passive device (or an ambient IoT device) may be an IoT device that can perform ambient energy harvesting, such as an electronic tag, for example an RFID tag. A passive device (or an ambient IoT device) may also be referred to as an ambient energy harvesting device. As used herein, the term “ambient IoT devices” may refer to active IoT devices, passive IoT devices, and/or semi-passive IoT devices.

In some examples, ambient IoT devices (e.g., active IoT devices, passive IoT devices, semi-passive IoT devices, etc.) are relatively low-cost and low-complexity devices that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink radio frequency (RF) signals, ambient energy harvesting devices (e.g., ambient IoT devices) may be provided without an energy storage element and/or can be provided with a relatively small energy storage element (e.g., battery, capacitor, etc.). The RF signals can be transmitted by a reader device. For example, a reader device can transmit downlink RF signals to energy harvesting devices, which can be used to energize the energy harvesting devices. In some cases, a reader device may be an energy source network device, such as in the form of a mobile device (e.g., a mobile phone, a handheld device, etc.). Ambient energy harvesting devices provided without an energy storage element may include passive IoT devices. Ambient energy harvesting devices provided with a relatively small energy storage element may include semi-passive IoT devices. Ambient energy harvesting devices that are provided with an energy storage element may include active IoT devices. Energy harvesting devices can be deployed at large scales, based on the simplification in their manufacture and deployment associated with implementing wireless energy harvesting.

In some examples, ambient energy harvesting devices can harvest energy from dedicated downlink RF signals for energy harvesting. In some cases, an ambient energy harvesting device may be configured to perform energy harvesting only for dedicated downlink RF signals for energy harvesting. In some cases, ambient energy harvesting devices can harvest energy from ambient downlink RF signals (e.g., including dedicated downlink RF signals for energy harvesting and various other downlink RF signals that are not dedicated energy harvesting signals).

In some cases, an ambient energy harvesting device can use the same antenna for energy harvesting and communications. For example, an ambient energy harvesting device can use the same antenna to perform energy harvesting and backscatter communications, where the energy harvesting and the backscatter communications are based on the same downlink RF signal.

In some examples, an ambient energy harvesting device can include a first antenna used for energy harvesting and a second antenna used for communications, where the first antenna is different from the second antenna. For instance, an ambient IoT device can use the first antenna to perform energy harvesting and can use the second antenna to perform communication (e.g., transmitting and/or receiving).

The backscatter transmitter can generate and transmit an uplink signal by reflecting and backscatter modulating an incident downlink signal using the first antenna. In some examples, an ambient IoT device can use a backscatter transmitter that is the same as or similar to a backscatter transmitter utilized by a passive or semi-passive IoT device, as described above. An active transmitter can use a battery or other energy storage element included in the ambient IoT device to generate and transmit an uplink signal, using an antenna that is different from the first antenna associated with the backscatter transmitter (e.g., a second antenna). To transmit an uplink signal, the backscatter transmitter of an ambient IoT device must first receive a downlink signal that can be reflected and backscatter modulated. For example, the backscatter transmitter may be unable to transmit an uplink signal unless or until a continuous sine wave is received as a downlink signal from a reader device or other energy source network device. The active transmitter of an ambient IoT device can perform uplink communication that is triggered by the ambient IoT device (e.g., without dependence on first receiving a downlink signal). In some examples, ambient IoT devices may include a small battery or energy storage element and may be unable to sustain longer periods of uplink communication using the active transmitter of the ambient IoT device. For example, active transmission by an ambient IoT device may quickly deplete the onboard battery or other energy storage element(s) included in the ambient IoT device.

In a wireless communication network environment, a network device (e.g., such as an energizing device) can be used to transmit downlink RF signals to energy harvesting devices. In some cases, the network device can be in the form of a mobile device, such as a mobile phone. In some aspects, the network device may also be referred to herein as a “reader device”, an “energy source,” a “scheduler of energy transfer,” and/or an “energy transfer scheduler.”

Currently, passive devices, in the form of electronic tags (e.g., RFID tags), are a rapidly growing technology impacting many industries, due to their economic potential for inventory and/or asset management inside and outside warehouses, IoT devices, sustainable sensor networks in factories and/or agriculture, and smart home usage. Electronic tags consist of small transponders, or tags, that emit an information-bearing signal after receiving a signal. Electronic tags operate without a battery at a low operating expense (OPEX), with a low maintenance cost, and with a long-life cycle. Electronic tags can harvest energy over-the-air and power their transmission and reception circuitry.

In some examples, passive IoT devices can be used to provide sensing capabilities for various processes and use cases, such as asset management, logistics, warehousing, manufacturing, etc. (e.g., to monitor, track, and locate items associated with the passive IoT devices, where in some cases the items may be retail or industrial goods or products). Passive IoT devices can include one or more sensors, a processor or micro-controller, and an energy harvester for generating electrical power from incident downlink (DL) radio frequency (RF) signals received at the passive IoT device. Based on harvesting energy from incident downlink RF signals (e.g., transmitted by a network device, such as a reader device or an interrogator), energy harvesting devices (e.g., such as passive IoT devices, which may be in the form of electronic tags) can be provided with a relatively small energy storage element, such as in the form of a capacitor. Energy harvesting devices can be deployed at large scales, based on the simplification in their manufacture and deployment associated with implementing wireless energy harvesting.

As noted previously, a device (e.g., such as a reader device or interrogator) can be used to transmit downlink RF signals to energy harvesting devices. In one illustrative example, a reader device can read and/or write information stored on energy harvesting IoT devices (e.g., electronic tags, which may each be associated with a respective item) by transmitting the downlink RF signal. The downlink RF signal can provide energy to an energy harvesting IoT device. The energy harvesting IoT device can transmit (e.g., based on reflecting or backscattering a portion of the incident downlink RF signal) a response signal (e.g., an information-bearing uplink signal) back to the reader device, after the energy harvesting IoT device is sufficiently energized. The reader device can read the signal transmitted by an energy harvesting IoT device to decode the information transmitted by the IoT device (e.g., such as sensor information collected by one or more sensors included in the IoT device, etc.).

In some examples, for a given downlink signal with a given input RF power received at an ambient energy harvesting device, a first portion of the input RF power is provided to the device's energy harvester (e.g., with a percentage being converted to useful electrical power based on the conversion efficiency of the harvester, and the remaining percentage wasted or dissipated as heat, etc.). A remaining, second portion of the input RF power is available for use in the backscattered uplink transmission (e.g., the second portion of the input power is reflected and modulated with the uplink communication).

An energy harvesting tag (EH-tag) system is an ambient IoT system. The system generally includes an energizer (e.g., a reader device or interrogator) and an electronic tag (e.g., which is a low cost device). An electronic tag does not include a battery and relies on wireless power transfer (WPT) from over-the-air to perform energy harvesting (e.g., to harvest energy from the wireless signals transmitted from the energizer). The energizer can send a downlink wireless power transfer waveform (e.g., including a continuous waveform) to the electronic tags.

As previously mentioned, electronic tags (e.g., RFID tags) are low-complexity devices. Security and privacy protection (e.g., for the electronic tags as well as for items associated with the electronic tags) can be challenging because electronic tags, due to their low complexity, may not be able to implement various different cryptography algorithms (e.g., secure hash algorithm 2 (SHA-2), Rivest-Shamir-Adleman (RSA) algorithm, and/or elliptic curve cryptography (ECC) algorithm) to maintain security for key derivation, encryption, and/or integrity protection. The electronic tags may only be able to support basic computations, such as exclusive or (XOR) and addition by an adder (ADD). Timed security and privacy operations (e.g., a key change and/or an identification number change) may not easily be supported by electronic tags, because electronic tags typically do not include a clock. However, in some cases, some existing electronic tags may be able to support a clock for such purposes.

Electronic tags (e.g., RFID tags) can be subject to security attacks because electronic tags operate by using external power (e.g., operate via energy harvesting). The harvesting of energy can continuously trigger the occurrence of certain operations (e.g., to perform inventory in response to being energized or interrogated by a reader device) that can require cryptography operations. Desynchronization attacks or denial of service attacks can be launched against electronic tags via the external power provided to the electronic tags. Without the inclusion of a clock, synchronization of electronic tags with a server (e.g., a network server, which may be in the form of a cloud server) can be extremely difficult.

As previously described, electronic tags (e.g., RFID tags), when energized with an energizing signal (e.g., transmitted from a reader device), can generate or produce a backscatter signal that includes information. The energizing signal may be a downlink RF signal, which can include input RF power in the form of a wireless power transfer waveform (e.g., including a continuous waveform). The backscatter signal can be generated (e.g., by the electronic tag) by reflecting and modulating a portion of the input RF power from the energizing signal. The information in the backscatter signal may include, but is not limited to, an electronic product code (EPC) that is associated with a type of product of an item associated with the electronic tag and include a tag identification (TID) (e.g., a unique number identifier) that is associated with the particular electronic tag being energized. This information can be used by an inventory system (e.g., a network server, such as a cloud server) to monitor, track, and locate the item associated with the electronic tag within a retail store or warehouse. After ownership of the item is passed from the owner of the retail store or warehouse to a new owner (e.g., a customer), to avoid continual tracking of the item for customer privacy reasons, the information (e.g., including the TID) of the electronic tag is typically disabled. However, in the case of the item becoming lost by the new owner at a later date, it can be advantageous to be able to use the information (e.g., including the TID) associated with the electronic tag to locate the item for the new owner in a secure way that provides a level of privacy to the new owner.

As such, improved systems and techniques for providing a lost and found service for a passive device (e.g., an electronic tag, such as an RFID tag) for locating an item associated with the passive device in a secure way that provides a level of privacy to the owner of the item can be beneficial.

In some aspects of the present disclosure, systems, apparatuses, methods (also referred to as processes), and computer-readable media (collectively referred to herein as “systems and techniques”) are described herein for a lost and found service for a passive device, such as a low complexity RFID tag.

Various aspects relate generally to wireless communications. Some aspects more specifically relate to systems and techniques that provide solutions for an electronic tag (e.g., RFID tag) system backed by a server (e.g., a cloud server, such as a lost and found server) to provide a lost and found service for items associated with electronic tags. In one or more examples, the system and techniques employ a single cryptography algorithm for cryptography operations and a timer to mitigate potential security and privacy attacks, as well as add intelligence at the cloud server.

In one or more examples, for the lost and found service of the systems and techniques, one or more passive devices (e.g., electronic tags, such as RFID tags) can be onboarded into a lost and found cloud server. A reader device can be used to periodically record (e.g., track) the location of the passive devices, and update the latest locations of the passive devices in the lost and found cloud server. The lost and found cloud server can be queried by a network device (e.g., an owner device associated with an owner of an item associated with a passive device) to locate a lost passive device associated with an item owned by the owner.

As mentioned, the passive devices (e.g., electronic tags, such as RFID tags) are low complexity devices, which are low power and have low computational capabilities. As such, the passive devices do not support advanced cryptography algorithms and do not include a clock (e.g., because the passive devices do not include a battery, and obtain their energy from external sources). Since the passive devices may not support various cryptography algorithms due to its low complexity, the passive devices utilize a single cryptography algorithm (e.g., an advanced encryption standard (AES) algorithm) for those features requiring cryptography operations. The reader device, being of more complexity of the passive devices, can utilize an elliptic curve cryptography (ECC) algorithm (e.g., an elliptic-curve Diffie-Hellman (ECDH) algorithm) for encrypting the location of the reader device. A timer reset may occur when a passive device is enabled (e.g., energized) by an external source (e.g., a reader device). The systems and techniques provide a passive device based lost and found system that can operate over an uncertain, low grade platform and framework by setting up some minimal additional requirements.

In one or more examples, during operation of the systems and techniques for wireless communications performed at a passive device, the passive device can generate private information based on applying a cryptographic algorithm to information using a secret key. In one or more examples, a secret key is a variable, such as a seed, in cryptography that can be used with an algorithm to encrypt and/or decrypt data. In one or more examples, the information can be associated with the passive device and with an item associated with the passive device. The passive device can receive, from a reader device, an energizing signal. The passive device can transmit, based on receiving the energizing signal, a backscatter signal to the reader, wherein the backscatter signal comprises the private information.

In one or more examples, the reader device can validate, with a server, that the private information is registered with the passive device. The reader device can determine a location of the reader device. For example, the reader device can associate a backscatter signal (read from the passive device) with its location, where the location can be determined by the reader device (e.g., using GNSS). The reader device can encrypt the location based on a public key associated with the secret key to generate an encrypted location. The reader device can send the encrypted location to the server. In one or more examples, the passive device can provide, to a network device, the secret key. In some examples, the network device can receive the encrypted location from the server, can decrypt the encrypted location based on the secret key to determine the location of the reader, and can determine an estimated location of the item based on the location of the reader.

In some examples, the information can include an electronic product code (EPC) associated with the item and a tag identification (TID) associated with the passive device. In one or more examples, the information can further include a timer value or a counter value associated with a time of generating of the private information. In one or more examples, the cryptographic algorithm can be an advanced encryption standard counter mode (AES-CTR) or an AES cipher-based message authentication code (AES-CMAC) algorithm. The AES-CMAC algorithm is a cryptographic algorithm typically used for integrity protection (e.g., for generating a Message Authentication Code (MAC))). According to various aspects, the AES-CMAC algorithm can be used to generate the private information, such as a private identification number (e.g., a temporary identifier), instead of an HMAC.

In one or more examples, the passive device can receive, from the reader device, a token. In some examples, the token can be generated by the network device based on the secret key, and the public key. In one or more examples, the passive device can verify the public key is associated with the passive device by decrypting, based on the secret key, the token to generate the public key.

In some examples, the passive device can start, based on the passive device receiving the energizing signal from the reader, a timer associated with the passive device. In one or more examples, the private information can be generated by the passive device when the timer expires. In some examples, the private information can be stored and used until the timer expires. In some examples, the timer can expire when charge of a capacitor of the passive device has been fully depleted (e.g., fully discharged). In one or more examples, the passive device can set, based on expiration of the timer, a private information flag to indicate to the passive device to generate the private information.

In one or more examples, the passive device is a radio frequency identification (RFID) tag. In some examples, the network device (e.g., an owner device) is associated with a user (e.g., an owner) associated with the item, which is associated with the passive device (e.g., RFID tag). The network device (e.g., owner device) can be used to track the passive device to locate the item. In one or more examples, the server can be a cloud server.

In some examples, during operation of the systems and techniques for wireless communications performed at a network device, the network device can register, with a server, private information and a public key associated with a secret key. In one or more examples, the private information can be generated by the passive device applying a cryptographic algorithm to information using the secret key. In some examples, the information can be associated with the passive device and with an item associated with the passive device. The network device can receive, from the server, an encrypted location of a reader device. In one or more examples, the encrypted location of the reader device can be generated based on an elliptic curve cryptography (ECC) algorithm. In some examples, the encrypted location can be associated with a backscatter signal from the passive device generated based on the reader device energizing the passive device. The network device can decrypt, based on the secret key, the encrypted location to determine a location of the reader device. The network device can determine, based on the location of the reader device, an estimated location of the item.

In one or more examples, the network device can generate, based on the secret key, the public key and further generate a token for verifying the public key is associated with the passive device. In some examples, the network device can transmit the token to the server. In some examples, the server can transmit the token to the reader. In one or more examples, the passive device can confirm the public key is associated with the passive device to the reader by verifying, based on the secret key, the token.

Various aspects of the systems and techniques described herein will be discussed below with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

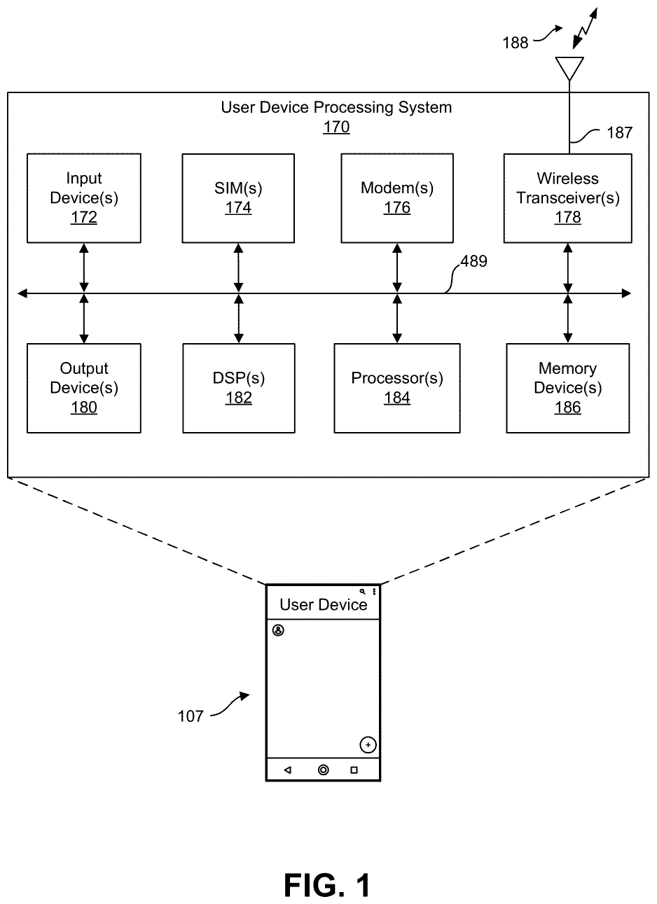

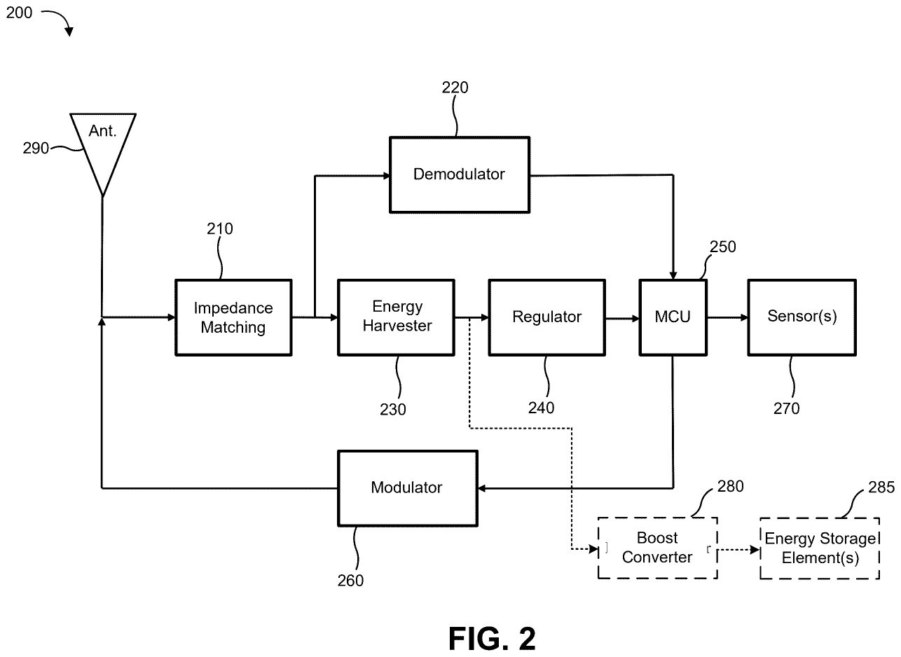

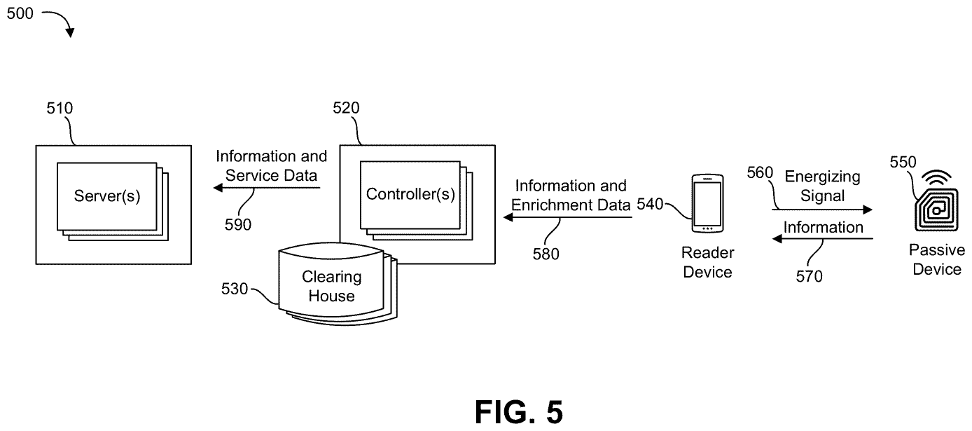

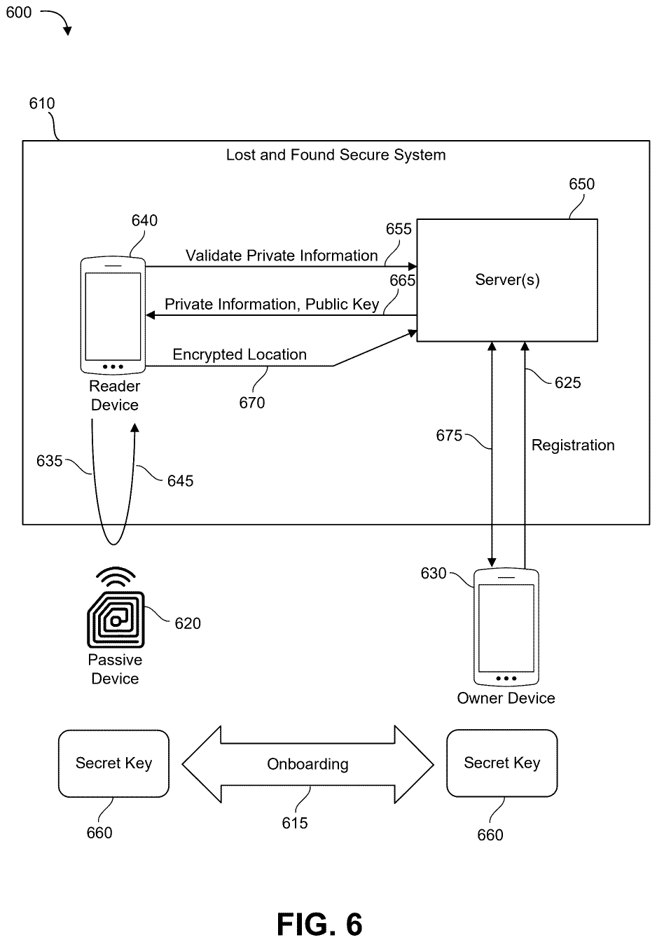

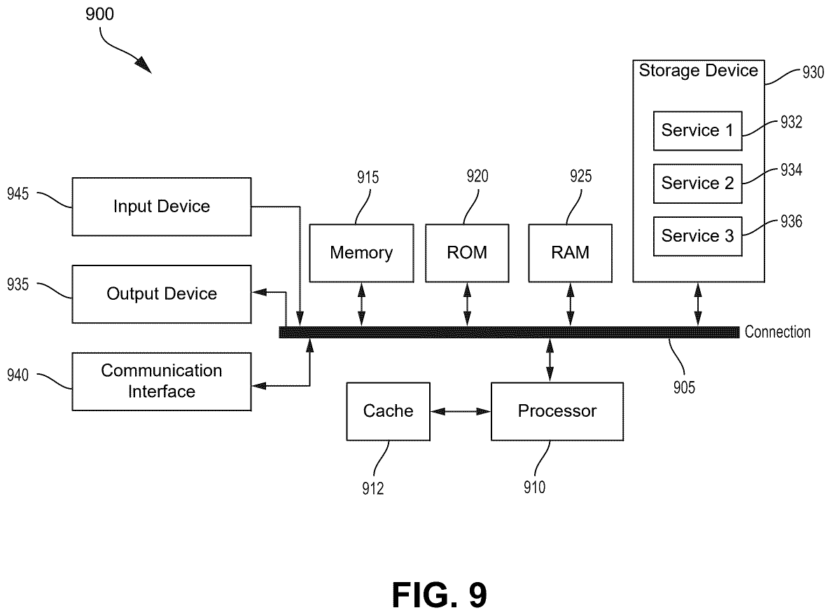

In some examples, any of the devices and/or apparatuses described herein (e.g., a passive device such as the RF energy harvesting device 200 of FIG. 2, the passive device 550 of FIG. 5, the passive device 620 of FIG. 6, etc., a server such as the server 510 of FIG. 5, the server 650 of FIG. 6, etc., a reader device such as the reader device 580 of FIG. 5, the reader device 640 of FIG. 6, etc., and/or other device) may include a processing system (e.g., such as the processing system 170 of FIG. 1 and/or the processing system 910 of FIG. 9, etc.). A processing system may include one or more components (or subcomponents), such as one or more components described herein. For example, a respective component of the one or more components may be, be similar to, include, or be included in at least one memory, at least one communication interface, and/or at least one processor. In some cases, the one or more components may include a first component, a second component, and/or a third component. In one illustrative example, the processing system can include the first component and the second component, where the first component may be coupled to the second component. In this example, the first component may be at least one processor and the second component may be at least one memory. In another illustrative example, the processing system can include the first component, the second component, and the third component, where the first component may be coupled to the second component and the third component. In this example, the first component may be at least one processor, the second component may be at least one memory, and the third component may be a communication interface.

A processing system may generally be a system including one or more components that may perform one or more functions, such as any function or combination of functions described herein. For example, one or more components (e.g., at least one communication interface) may receive input information (e.g., any information that is an input, such as a signal, any digital information, or any other information), one or more components (e.g., at least one processor) may process the input information to generate output information (e.g., any information that is an output, such as a signal or any other information), one or more components (e.g., at least one memory) may store information (e.g., the processed input information), one or more components may perform any other function(s) as described herein, or any combination thereof. As described herein, an “input” and “input information” may be used interchangeably. Similarly, as described herein, an “output” and “output information” may be used interchangeably. Any information generated by any component may be provided to one or more other systems or components of, for example, one or more devices described herein, such as a passive device, a server, a reader device, and/or other device).

For example, a processing system may include a first component configured to receive or obtain information, a second component configured to process the information to generate output information, and/or a third component configured to provide the output information to other systems or components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a processing system may include at least one memory, at least one communication interface, and/or at least one processor, where the at least one processor may, for example, be coupled to the at least one memory and the at least one communication interface.

A processing system of a device described herein (e.g., a passive device, a server, a reader device, etc.) may interface with one or more other components of the device, may process information received from one or more other components (such as input information), or may output information to one or more other components. For example, a processing system may include a first component configured to interface with one or more other components of the device to receive or obtain information, a second component configured to process the information to generate one or more outputs, and/or a third component configured to output the one or more outputs to one or more other components. In this example, the first component may be a communication interface (e.g., a first communication interface), the second component may be at least one processor (e.g., that is coupled to the communication interface and/or at least one memory), and the third component may be a communication interface (e.g., the first communication interface or a second communication interface). For example, a chip (e.g., a chipset, a system-on-chip (SoC), modem, etc.) of the device may include a processing system. The processing system may include a first communication interface to receive or obtain information, and a second communication interface to output, transmit, and/or otherwise provide information. In some examples, the first communication interface may be an interface configured to receive input information, and the information may be provided to the processing system. In some examples, the second system interface may be configured to transmit information output from the chip or modem. The second communication interface may also obtain or receive input information, and the first communication interface may also output, transmit, or provide information.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

FIG. 1 illustrates an example of a processing system 170 of a wireless device 107. The wireless device 107 may include a reader device (e.g., an energizing device) or other type of device (e.g., a network device, such as an owner device) that may be used by an end-user (e.g., an owner of an item associated with a passive device, such as an electronic tag, for example an RFID tag). For example, the wireless device 107 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The processing system 170 includes software and hardware components that may be electrically or communicatively coupled via a bus 189 (e.g., or may otherwise be in communication, as appropriate). For example, the processing system 170 includes one or more processors 184. The one or more processors 184 may include one or more CPUs, ASICs, FPGAs, APs, GPUs, VPUs, NSPs, microcontrollers, dedicated hardware, any combination thereof, and/or other processing device or system. The bus 189 may be used by the one or more processors 184 to communicate between cores and/or with the one or more memory devices 186.

The processing system 170 may also include one or more memory devices 186, one or more digital signal processors (DSPs) 182, one or more SIMs 174, one or more modems 176, one or more wireless transceivers 178, an antenna 187, one or more input devices 172 (e.g., a camera, a mouse, a keyboard, a touch sensitive screen, a touch pad, a keypad, a microphone, and/or the like), and one or more output devices 180 (e.g., a display, a speaker, a printer, and/or the like).

In some aspects, processing system 170 may include one or more radio frequency (RF) interfaces configured to transmit and/or receive RF signals. In some examples, an RF interface may include components such as modem(s) 176, wireless transceiver(s) 178, and/or antennas 187. The one or more wireless transceivers 178 may transmit and receive wireless signals (e.g., signal 188, which may be an energizing signal) via antenna 187 from one or more other devices, such as other wireless devices, network devices, passive devices, cloud servers, cloud networks, and/or the like. In some examples, the processing system 170 may include multiple antennas or an antenna array that may facilitate simultaneous transmit and receive functionality. Antenna 187 may be an omnidirectional antenna such that radio frequency (RF) signals may be received from and transmitted in all directions. The wireless signal 188 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 188 may be transmitted directly to other wireless devices using sidelink communications (e.g., using a PC5 interface, using a DSRC interface, etc.). Wireless transceivers 178 may be configured to transmit RF signals for performing sidelink communications via antenna 187 in accordance with one or more transmit power parameters that may be associated with one or more regulation modes. Wireless transceivers 178 may also be configured to receive sidelink communication signals having different signal parameters from other wireless devices.

In some examples, the one or more wireless transceivers 178 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 188 into a baseband or intermediate frequency and may convert the RF signals to the digital domain.

In some cases, the processing system 170 may include a coding-decoding device (or CODEC) configured to encode and/or decode data transmitted and/or received using the one or more wireless transceivers 178. In some cases, the processing system 170 may include an encryption-decryption device or component configured to encrypt and/or decrypt data (e.g., according to the AES and/or DES standard) transmitted and/or received by the one or more wireless transceivers 178.

The one or more SIMs 174 may each securely store an international mobile subscriber identity (IMSI) number and related key assigned to the user of the wireless device 107. The IMSI and key may be used to identify and authenticate the subscriber when accessing a network provided by a network service provider or operator associated with the one or more SIMs 174. The one or more modems 176 may modulate one or more signals to encode information for transmission using the one or more wireless transceivers 178. The one or more modems 176 may also demodulate signals received by the one or more wireless transceivers 178 in order to decode the transmitted information. In some examples, the one or more modems 176 may include a Wi-Fi modem, a 4G (or LTE) modem, a 5G (or NR) modem, and/or other types of modems. The one or more modems 176 and the one or more wireless transceivers 178 may be used for communicating data for the one or more SIMs 174.

The processing system 170 may also include (and/or be in communication with) one or more non-transitory machine-readable storage media or storage devices (e.g., one or more memory devices 186), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 186 and executed by the one or more processor(s) 184 and/or the one or more DSPs 182. The processing system 170 may also include software elements (e.g., located within the one or more memory devices 186), including, for example, an operating system, device drivers, executable libraries, and/or other code, such as one or more application programs, which may comprise computer programs implementing the functions provided by various aspects, and/or may be designed to implement methods and/or configure systems, as described herein.

FIG. 2 is a diagram illustrating an example of an architecture of a radio frequency (RF) energy harvesting device 200 (e.g., a passive device, such as an electronic tag, for example an RFID tag), in accordance with some examples. As will be described in greater depth below, the RF energy harvesting device 200 can harvest RF energy from one or more RF signals received using an antenna 290. As used herein, the term “energy harvesting” may be used interchangeably with “power harvesting.” In some aspects, energy harvesting device 200 can be implemented as an Internet-of-Things (IoT) device, can be implemented as a sensor, etc., as will be described in greater depth below. In other examples, energy harvesting device 200 can be implemented as an RFID tag or various other RFID devices.

The energy harvesting device 200 includes one or more antennas 290 that can be used to transmit and receive one or more wireless signals. For example, energy harvesting device 200 can use antenna(s) 290 to receive one or more downlink signals and to transmit one or more uplink signals. An impedance matching component 210 can be used to match the impedance of antenna(s) 290 to the impedance of one or more (or all) of the receive components included in energy harvesting device 200. In some examples, the receive components of energy harvesting device 200 can include a demodulator 220 (e.g., for demodulating a received downlink signal), an energy harvester 230 (e.g., for harvesting RF energy from the received downlink signal), a regulator 240, a micro-controller unit (MCU) 250, a modulator 260 (e.g., for generating an uplink signal). In some cases, the receive components of energy harvesting device 200 may further include one or more sensors 270.

The downlink signals can be received from one or more transmitters. For example, energy harvesting device 200 may receive a downlink signal from a network node or network device that is included in a same wireless network as the energy harvesting device 200. In some cases, the network device can be a reader device that communicates with the energy harvesting device 200.

In some cases, energy harvesting device 200 can be implemented as a passive or semi-passive energy harvesting device (e.g., an ambient energy harvesting device), which can perform passive uplink communication by modulating and reflecting a downlink signal received via antenna(s) 290. For example, passive and semi-passive energy harvesting devices may be unable to generate and transmit an uplink signal without first receiving a downlink signal that can be modulated and reflected. In other examples, energy harvesting device 200 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An ambient energy harvesting device (e.g., active or semi-passive energy harvesting device) may include one or more energy storage elements 285 (e.g., collectively referred to as an “energy reservoir”). For example, the one or more energy storage elements 285 can include batteries, capacitors, etc. In some examples, the one or more energy storage elements 285 may be associated with a boost converter 280. The boost converter 280 can receive as input at least a portion of the energy harvested by energy harvester 230 (e.g., with a remaining portion of the harvested energy being provided as instantaneous power for operating the energy harvesting device 200). In some aspects, the boost converter 280 may be a step-up converter that steps up voltage from its input to its output (e.g., and steps down current from its input to its output). In some examples, boost converter 280 can be used to step up the harvested energy generated by energy harvester 230 to a voltage level associated with charging the one or more energy storage elements 285. An ambient energy harvesting device (e.g., active or semi-passive energy harvesting device) may include one or more energy storage elements 285 and may include one or more boost converters 280. A quantity of energy storage elements 285 may be the same as or different than a quantity of boost converters 280 included in an active or semi-passive energy harvesting device.

A passive energy harvesting device does not include an energy storage element 285 or other on-device power source. For example, a passive energy harvesting device may be powered using only RF energy harvested from a downlink signal (e.g., using energy harvester 230). As mentioned previously, a semi-passive energy harvesting device can include one or more energy storage elements 285 and/or other on-device power sources. The energy storage element 285 of a semi-passive energy harvesting device can be used to augment or supplement the RF energy harvested from a downlink signal. In some cases, the energy storage element 285 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 285 and/or other on-device power sources that can power uplink communication without using supplemental harvested RF energy (e.g., minimum transmit power of the active device<capacity of the energy storage element). The energy storage element(s) 285 included in an active energy harvesting device and/or a semi-passive energy harvesting device can be charged using harvested RF energy.

As mentioned above, ambient energy harvesting devices (e.g., passive and semi-passive energy harvesting devices) transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, ambient energy harvesting devices (e.g., passive and semi-passive energy harvesting devices) may be unable to transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 200 is implemented as an ambient energy harvesting device (e.g., a passive or semi-passive energy harvesting device), a continuous carrier wave downlink signal may be received using antenna(s) 290 and modulated (e.g., re-modulated) for uplink communication. In some cases, a modulator 260 can be used to modulate the reflected (e.g., backscattered) portion of the downlink signal. For example, the continuous carrier wave may be a continuous sinusoidal wave (e.g., sine or cosine waveform) and modulator 260 can perform modulation based on varying one or more of the amplitude and the phase of the backscattered reflection. Based on modulating the backscattered reflection, modulator 260 can encode digital symbols (e.g., such as binary symbols or more complex systems of symbols) indicative of an uplink communication or data message. For example, the uplink communication may be indicative of sensor data or other information associated with the one or more sensors 270 included in energy harvesting device 200.

As mentioned previously, impedance matching component 210 can be used to match the impedance of antenna(s) 290 to the receive components of energy harvesting device 200 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna(s) 290. Based on varying the antenna impedance (e.g., varying the impedance mismatch between antenna(s) 290 and the remaining components of energy harvesting device 200), digital symbols and/or binary information can be encoded (e.g., modulated) onto the backscattered reflection. Varying the antenna impedance to modulate the phase and/or amplitude of the backscattered reflection can be performed using modulator 260.

As illustrated in FIG. 2, a portion of a downlink signal received using antenna(s) 290 can be provided to a demodulator 220, which performs demodulation and provides a downlink communication (e.g., carried or modulated on the downlink signal) to a micro-controller unit (MCU) 250 or other processor included in the energy harvesting device 200. A remaining portion of the downlink signal received using antenna(s) 290 can be provided to energy harvester 230, which harvests RF energy from the downlink signal. For example, energy harvester 230 can harvest RF energy based on performing AC-to-DC (alternating current-to-direct current) conversion, wherein an AC current is generated from the sinusoidal carrier wave of the downlink signal and the converted DC current is used to power the energy harvesting device 200. In some aspects, energy harvester 230 can include one or more rectifiers for performing AC-to-DC conversion. A rectifier can include one or more diodes or thin-film transistors (TFTs). In one illustrative example, energy harvester 230 can include one or more Schottky diode-based rectifiers. In some cases, energy harvester 230 can include one or more TFT-based rectifiers.

The output of the energy harvester 230 is a DC current generated from (e.g., harvested from) the portion of the downlink signal provided to the energy harvester 230. In some aspects, the DC current output of energy harvester 230 may vary with the input provided to the energy harvester 230. For example, an increase in the input current to energy harvester 230 can be associated with an increase in the output DC current generated by energy harvester 230. In some cases, MCU 250 may be associated with a narrow band of acceptable DC current values. Regulator 240 can be used to remove or otherwise decrease variation(s) in the DC current generated as output by energy harvester 230. For example, regulator 240 can remove or smooth spikes (e.g., increases) in the DC current output by energy harvester 230 (e.g., such that the DC current provided as input to MCU 250 by regulator 240 remains below a first threshold). In some cases, regulator 240 can remove or otherwise compensate for drops or decreases in the DC current output by energy harvester 230 (e.g., such that the DC current provided as input to MCU 250 by regulator 240 remains above a second threshold).

In some aspects, the harvested DC current (e.g., generated by energy harvester 230 and regulated upward or downward as needed by regulator 240) can be used to power MCU 250 and one or more additional components included in the energy harvesting device 200. For example, the harvested DC current can additionally be used to power one or more (or all) of the impedance matching component 210, demodulator 220, regulator 240, MCU 250, sensors 270, modulator 260, etc. For example, sensors 270 and modulator 260 can receive at least a portion of the harvested DC current that remains after MCU 250 (e.g., that is not consumed by MCU 250). In some cases, the harvested DC current output by regulator 240 can be provided to MCU 250, modulator 260, and sensors 270 in series, in parallel, or a combination thereof.

In some examples, sensors 270 can be used to obtain sensor data (e.g., such as sensor data associated with an environment in which the energy harvesting device 200 is located). Sensors 270 can include one or more sensors, which may be of a same or different type(s). In some aspects, one or more (or all) of the sensors 270 can be configured to obtain sensor data based on control information included in a downlink signal received using antenna(s) 290. For example, one or more of the sensors 270 can be configured based on a downlink communication obtained based on demodulating a received downlink signal using demodulator 220. In one illustrative example, sensor data can be transmitted based on using modulator 260 to modulate (e.g., vary one or more of amplitude and/or phase of) a backscatter reflection of the continuous carrier wave received at antenna(s) 290. Based on modulating the backscattered reflection, modulator 260 can encode digital symbols (e.g., such as binary symbols or more complex systems of symbols) indicative of an uplink communication or data message. In some examples, modulator 260 can generate an uplink, backscatter modulated signal based on receiving sensor data directly from sensors 270. In some examples, modulator 260 can generate an uplink, backscatter modulated signal based on received sensor data from MCU 250 (e.g., based on MCU 250 receiving sensor data directly from sensors 270).

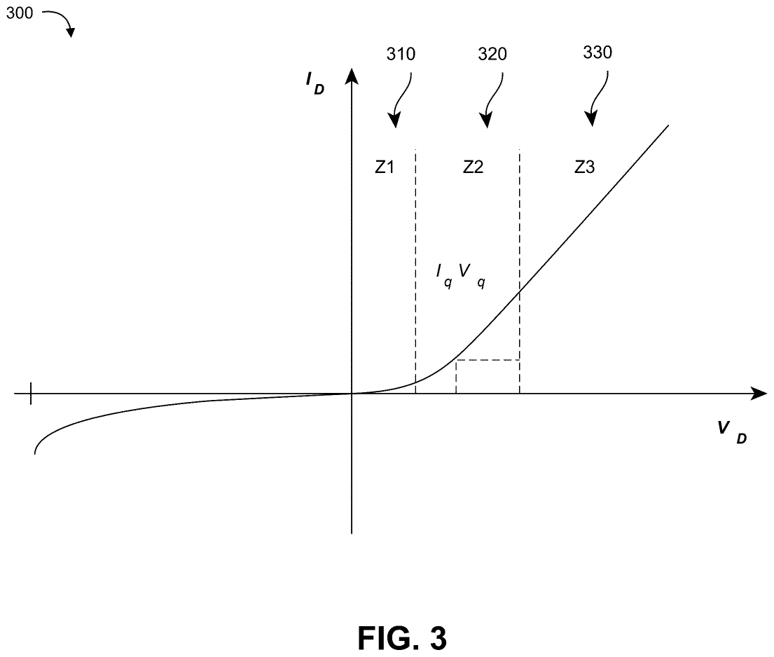

FIG. 3 is a diagram 300 illustrating an example of a small signal rectification operation that may be associated with performing energy harvesting, in accordance with some examples. In one illustrative example, the small signal rectification operation may be a small signal rectification operation associated with a Schottky diode barrier (e.g., a Schottky diode used to perform rectification associated with energy harvester 330 illustrated in FIG. 3).

In some cases, the rectification process in a diode barrier (e.g., Schottky diode or other diode) associated with performing energy harvesting can be classified into small signal operation and large signal operation. For example, large signal operation is associated with rectifying an input signal (e.g., a received downlink signal at an energy harvesting device that includes the diode) having a relatively large amplitude signal that causes the diode to operate in its resistive zone. Small signal operation (e.g., such as the example small signal operation illustrated in FIG. 3) can be associated with rectifying an input signal (e.g., or portion thereof) having a relatively small amplitude signal, such that the diode does not operate in its resistive zone.

For example, small signal operation of a rectifying process in a Schottky diode barrier may be associated with three different operating zones, as depicted in FIG. 3. In a first operating zone 310, the diode behavior may be approximated as quadratic. For example, in the first operating zone 310, the output signal of the diode may be proportional to the square of the input signal to the diode. In some cases, the first operating zone 310 may also be referred to as a square law zone. In a second operating zone 320, the diode behavior may become more affected by other contributions, and the relationship between the output-input signal of the diode may decrease from quadratic towards linear. In some cases, the second operating zone 320 may also be referred to as a transition zone. In a third operating zone 330, the output signal of the diode may be proportional to the input signal to the diode (e.g., a linear relationship between input and output signals of the diode) and no DC component is generated. The third operating zone 330 may also be referred to as a resistive zone.

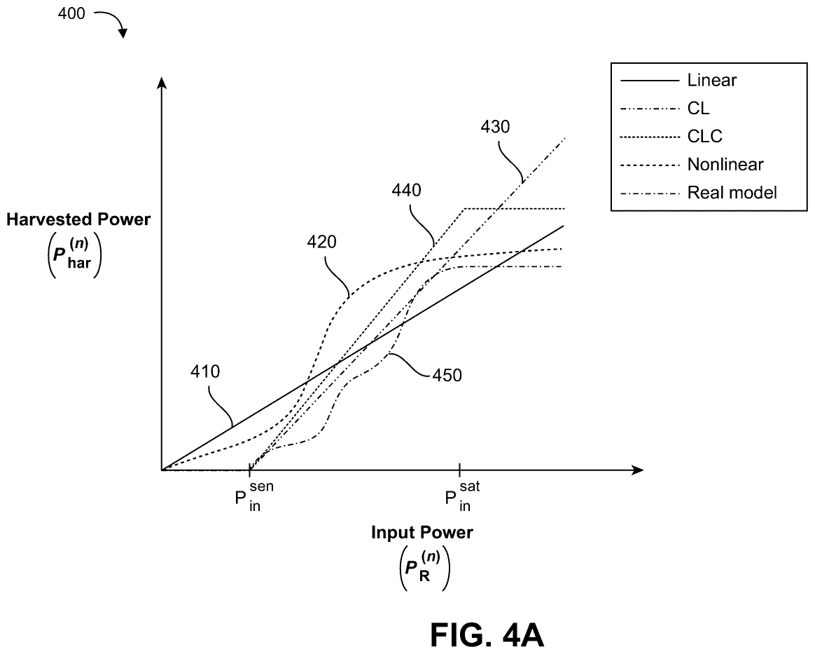

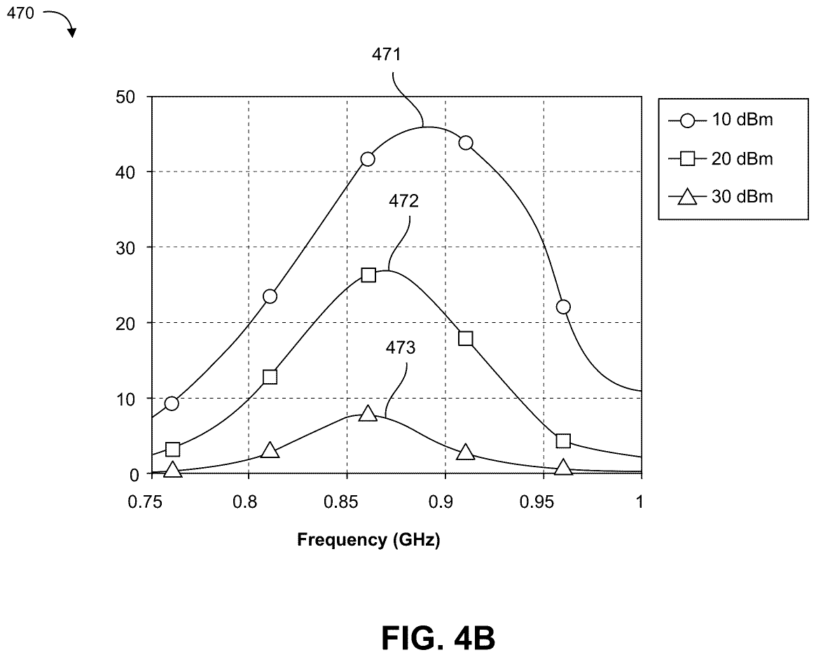

FIG. 4A is a diagram 400 illustrating examples of input power-harvested power conversion models that may be associated with various energy harvesting devices (e.g., such as the energy harvesting device 200 illustrated in the example of FIG. 2, above). Diagram 400 includes a first power conversion model 410, a second power conversion model 420, a third power conversion model 430, a fourth power conversion model 740, and a fifth power conversion model 450. In some aspects, different energy harvesting devices may be associated with different models between input power (e.g., the total RF energy or power of the portion of the received downlink signal provided to energy harvester 230 illustrated in FIG. 2) and harvested power (e.g., the RF energy or power that is harvested and output by energy harvester 230). In some aspects, the power conversion models 410-450 may be associated with ambient energy harvesting devices (e.g., passive and/or semi-passive energy harvesting devices) and/or active energy harvesting devices.

The first power conversion model 410 can be associated with a first type or category of energy harvesting devices. For example, energy harvesting devices having the first power conversion model 410 can provide harvested power as a continuous, linear, increasing function of the input RF power.

The second power conversion model 420 can be associated with a second type or category of energy harvesting devices. For example, energy harvesting devices having the second power conversion model 420 can provide harvested power as a continuous, non-linear, increasing function of the input RF power.

The third power conversion model 430 can be associated with a third type or category of energy harvesting device. For example, energy harvesting devices having the third power conversion model 430 can provide harvested power that is a continuous, linear, increasing function of the input RF power, given that the input RF power is above a sensitivity threshold

$$( {P}_{i n}^{s e n} ) .$$

The sensitivity threshold

$${P}_{in}^{s e n}$$

can represent a minimum input RF power for which the energy harvesting device is able to perform harvesting (e.g., is able to harvest a non-zero amount of power). When the input RF power is below the sensitivity threshold

$$( {P}_{i n}^{s e n} ) ,$$

the harvested power is zero.

The fourth power conversion model 440 can be associated with a fourth type or category of energy harvesting device. For example, energy harvesting devices having the fourth power conversion model 440 can provide harvested power that is a continuous, linear, increasing function of the input RF power, given that the input RF power is both above the sensitivity threshold

$${P}_{in}^{sen}$$

and is below a saturation threshold

$${P}_{in}^{sat} .$$

As illustrated, the saturation threshold

$${P}_{in}^{sen} .$$

is greater than the sensitivity threshold

$${P}_{in}^{sat}$$

When the input RF power is below the sensitivity threshold

$${P}_{in}^{sen} ,$$

the harvested power is zero. When the input RF power is above the saturation threshold

$${P}_{in}^{sat} ,$$

the harvested power output saturates (e.g., remains approximately constant for any input RF power above the saturation threshold).

The fifth power conversion model 450 can be associated with a fifth type or category of energy harvesting device. For example, for an input RF power between the sensitivity threshold

$${P}_{in}^{sen}$$

and the saturation threshold

$${P}_{in}^{sat} ,$$

energy harvesting devices having the fifth power conversion model 450 can provide harvested power that is a continuous, non-linear, increasing function of the input RF power.

In some examples, an efficiency of an energy harvesting device can be determined as a percentage of the input RF power that is converted into harvested power. FIG. 4B is a diagram 470 illustrating an example of energy conversion efficiency vs. frequency (e.g., of an input waveform to the energy harvesting device) for different input powers. For example, a first efficiency-frequency relationship 471 is shown for an input RF power of −10 dBm (decibel milliwatts), a second efficiency-frequency relationship 472 is shown for an input RF power of −20 dBm, and a third efficiency-frequency relationship 473 is shown for an input RF power of −30 dBm.

The three efficiency-frequency relationships 471, 472, 473 depicted in FIG. 4B may each be associated with an optimum operating frequency, or an optimum operating frequency band, for which the energy conversion efficiency of a corresponding energy harvesting device is maximized. For example, for an input RF power of −30 dBm, an energy harvesting device with the third energy conversion model 473 may maximize its energy conversion efficiency with an input RF waveform centered at a frequency of 0.86 GHz. In another example, for an input RF power of −20 dBm, an energy harvesting device with the second energy conversion model 472 may maximize its energy conversion efficiency with an input RF waveform centered at a frequency of 0.87 GHz. In another example, for an input RF power of −10 dBm, an energy harvesting device with the first energy conversion model 471 may maximize its energy conversion efficiency with an input RF waveform centered at a frequency of 0.89 GHz.

The efficiency of an energy harvesting device may vary based on the input RF power (e.g., the RF power of the downlink signal received at an antenna of the energy harvesting device) and the center frequency of the input RF waveform. For example, as illustrated in FIG. 4B, the maximum or peak efficiency of an energy harvesting device that receives a relatively low input RF power may be less than the maximum or peak efficiency of an energy harvesting device that receives a relatively high input RF power (e.g., at −30 dBm the peak efficiency of energy conversion model 473 is below 10%, at −20 dBm the peak efficiency of energy conversion model 472 is approximately 25%, and at −10 dBm the peak efficiency of energy conversion model 471 is approximately 45%). In some cases, conversion efficiency can decrease for frequencies that are greater than the optimum input center frequency and can decrease for frequencies that are less than the optimum input center frequency.

In some aspects, the conversion efficiency of an energy harvesting device may be associated with one or more energy conversion characteristics (e.g., also referred to as energy harvesting characteristics). For example, one or more characteristics may be indicative of a relationship between the conversion efficiency of an energy harvesting device and input frequency. In one illustrative example, an energy harvesting device may have an approximately constant conversion efficiency over a narrowband operating bandwidth (e.g., such as 20 MHz or less). In such examples, the energy harvesting device can receive RF energy from a multi-sine downlink wave with uniform power distribution. In another illustrative example, an energy harvesting device with a wideband operating bandwidth (e.g., such as 20 MHz or greater) may have a conversion efficiency that is a non-linear function of input frequency over the wideband. In such examples, the energy harvesting device may receive RF energy based on Gaussian and/or raised-cosine filters being used in combination with (e.g., on top of) the multi-sine downlink wave described above for narrowband operating bandwidths.

In some aspects, the energy conversion efficiency of an energy harvesting device may vary continuously with the input RF power. For example, the energy conversion efficiency may be zero for input powers less than the sensitivity threshold

$$( {P}_{in}^{sen} )$$

(e.g., based on the harvested power being equal to zero when the input RF power is below the sensitivity threshold, and conversion efficiency=harvested power/input RF power). In some examples, the energy conversion efficiency of an energy harvesting device may vary over different input frequencies (e.g., as described above with respect to FIG. 4B) and may additionally vary over different input RF powers. For example, in some cases the energy conversion efficiency of an energy harvesting device may be approximately linear with input RF power, for input RF power values between the sensitivity threshold

$$( {P}_{in}^{sen} )$$

and a first input RF power value greater than

$${P}_{in}^{sen} .$$

The energy conversion efficiency may increase linearly with the input RF power from and above

$${P}_{in}^{sen} .$$

At input RF powers beyond the linear conversion efficiency zone, the energy conversion efficiency of the energy harvesting device may increase and/or decrease non-linearly with further increases in input RF power. In some examples, the energy conversion efficiency may include one or more additional zones of linear increase (e.g., and/or linear decrease) with input RF power, in addition to an initial linear conversion efficiency zone beginning at the sensitivity threshold

$${P}_{in}^{sen} .$$

As previously mentioned, currently, passive devices (e.g., electronic tags, such as RFID tags), when energized with an energizing signal (e.g., transmitted from a reader device), backscatter a signal (e.g., generate or produce a backscattered signal) including information. The information can include an electronic product code (EPC) that is associated with a type of product of an item associated with the electronic tag and include a tag identification (TID) (e.g., a unique number identifier) that is associated with the particular electronic tag being energized. This information may be used by an inventory system (e.g., a network server, such as a cloud server) to monitor, track, and locate the item associated with the electronic tag within a retail store or warehouse. After ownership of the item is passed from the owner of the retail store or warehouse to a new owner (e.g., a customer), to avoid continual tracking of the item for customer privacy reasons, the information (e.g., including the TID) of the electronic tag is typically disabled. In the case of the item becoming lost by the new owner at a later date, it can be helpful to be able to use the information (e.g., including the TID) associated with the electronic tag to locate the item for the new owner in a secure way that provides a level of privacy to the new owner. Therefore, improved systems and techniques for providing a lost and found service for a passive device (e.g., an electronic tag, such as an RFID tag) for locating an item associated with the passive device in a secure way that provides a level of privacy to the owner of the item can be useful.

In one or more aspects, the systems and techniques provide for a lost and found service for a passive device, such as a low complexity RFID tag. In one or more examples, the systems and techniques provide an electronic tag (e.g., RFID tag) system backed by a server (e.g., a cloud server, such as a lost and found server) to provide a lost and found service for items associated with electronic tags (e.g., RFID tags). In some examples, the system and techniques utilize a single cryptography algorithm for cryptography operations as well as a timer to mitigate potential security and privacy attacks, and add intelligence at the cloud server.

In one or more examples, a goal of the systems and techniques is to provide a secure global lost and found service for passive devices (e.g., electronic tags, such as RFID tags). The lost and found service may extend to near field communication (NFC), two dimensional (2D) bar codes, Bluetooth low energy (BLE) tags, and/or other types of electronic tags. The systems and techniques may employ attested reader devices to enable an open ecosystem for the lost and found services. In one or more examples, the reader devices may be implemented into consumer handsets (e.g., mobile devices, such as mobile phones), personal computers, vehicles, integrated health home (IHH) devices, etc. The use of the reader devices along with low cost electronic tags (e.g., RFID tags) embedded or attached to items can enable a super scaled global tracking service to locate lost items.

In one or more examples, electronic tags (e.g., RFID tags), which are very low cost (e.g., costing only a few cents per tag), associated with items (e.g., products) can be utilized to allow for a very large amount (e.g., hundreds of trillions) of unique items to be tracked globally. In one or more examples, the lost and found service of the systems and techniques utilize, to locate a lost item, an encrypted location of a reader device that energizes an electronic tag associated with the lost item, an encrypted electronic product code (EPC) associated with the lost item, and a shared secure registration of the electronic tag along with middleware of the electronic tag. In some examples, private information (e.g., an encrypted EPC, which may be referred to as a private EPC (pEPC)) may be defined outside of the current GS1 ecosystem (e.g., which provides global standards for barcodes) to be able to securely scale the lost and found system to have a low number of pEPC collisions.

In one or more aspects, the systems and techniques provide a private and secure lost and found solution for consumer and industrial electronic tag (e.g., RFID tag) enabled products. In one or more examples, the systems and techniques provide solutions for the following example scenarios. In one example scenario, after purchase of an item by a user (e.g., a consumer) from a retail store or warehouse, a product RFID tag password and privacy ownership associated with the item may be transferred to the user. If the user (e.g., consumer) returns the item back to the retail store or warehouse, the item will need to be added back into the industrial inventory system. However, if the user loses the RFID tag password (or the password is hacked, becomes corrupt, or is disabled), it can be difficult to add the item back into the inventory system. In another example scenario, electronic tags (e.g., RFID tags) provide their product serial numbers (e.g., tag identification numbers) to all reader devices. For this scenario, it can be difficult to maintain consumer privacy and security.

In one or more examples, currently, for GS1 industrial use cases, the full EPC of an electronic tag is read, and there is no privacy concern. For GS1 industrial use cases, it can be assumed that a second generation (Gen2) privacy mode is not turned on (e.g., not enabled). In one or more examples, a home geofence can be compared against an industrial area to determine whether it is an industrial use case. If it is determined that it is an industrial use case with privacy or authentication needed, then to enable privacy for an electronic tag, Gen2 privacy mode can be turned on for the electronic tag (e.g., there will be no serial number or a reduced range, and the password ownership can be enabled on/off). In some examples, the electronic tag can be authenticated using a reader device.

In some examples, for GS1 consumer use cases, it can be assumed that a Gen2 privacy mode is turned on (e.g., enabled). The user (e.g., consumer) of the item may lose the tag password. In one or more examples, a home geofence can be compared against an industrial area to determine whether it is a consumer use case. If it is determined that it is a consumer use case, then privacy may be a concern. If privacy is a concern, it can be confirmed that Gen2 privacy mode has been turned on for the electronic tag. In one or more examples, if privacy is a concern, the GS1 system may be upgraded with a lost and found secure layer only at the device level.

In one or more examples, for lost and found industrial and/or consumer use cases, a lost and found secure system may be employed for both industrial and consumer use cases to provide privacy and authentication services. In one or more examples, the location of a reader device, which energizes an electronic tag associated with a lost item, can be encrypted and sent to a server (e.g., cloud server), where only the owner of the lost item can decrypt the encrypted location. In one or more examples, non-serialized obfuscated data may be enabled to a consumer packaged good (CPG), while maintaining user privacy.

In one or more aspects, for an example lost and found use case, a user (e.g., customer) may purchase an item (e.g., a high value product) associated with an electronic tag (e.g., RFID tag). The electronic tag may be scanned (e.g., by a reader device or owner device), and the item associated with the electronic tag can be onboarded into a lost and found system (e.g., a lost and found server, which may be in the form of a cloud server). All reader devices of the lost and found service can regularly scan (e.g., one scan every minute) for electronic tags associated with nearby items, and can securely push a location of the reader device when scanning the items to the server (e.g., where the location of the reader device may be used as an approximate location of the items). An owner (e.g., customer) of an lost item can obtain a notification of the approximate location of the item from the server.

In some aspects, for the lost and found service of the systems and techniques, secure (e.g., encrypted) electronic tags (e.g., RFID tags) may be associated with (e.g., attached to or embedded within) an item (e.g., a product). The electronic tag can support the lost and found secure features. A user (e.g., which may be an owner) can use a reader device (e.g., which may be a mobile device, such as a mobile phone, or a personal computing device) to scan nearby electronic tags to track items associated with the electronic tags. The reader device may be subscribed to the lost and found service for securely locating lost items. Reader devices can regularly scan (e.g., one scan per minute) for electronic tags associated with nearby items, and securely push the location of the reader device when scanning the items to the lost and found server along with the information read from the electronic tags. Electronic tag and digital ownership can be transferred from the industrial owner to a user (e.g., customer), after the user purchases the item associated with the electronic tag. A retail and/or industrial product database can be used to transfer the digital ownership to the user (e.g., customer). The lost and found ecosystem (e.g., including a lost and found server) can provide a global secure encrypted product location and tracking service. The lost and found service may extend to NFC, 2D bar codes, BLE tags, and/or other types of electronic tags.

In one or more aspects, during operation of the lost and found service, a user (e.g., customer) purchases an item (e.g., a product) associated with an electronic tag (e.g., an RFID tag), and the digital ownership of the item is transferred from the retail store to the user. The user can use their device (e.g., owner device, which may be a mobile device, such as a mobile phone) to scan and register the electronic tag (e.g., associated with the purchased item) into the lost and found service (e.g., lost and found server). Reader devices (e.g., which may be other owner devices) may regularly scan electronic tags of nearby items, and push the locations of the reader devices when scanning the items to the lost and found server. If the user (e.g. customer) loses the purchased item, the user (e.g., customer) can obtain the location of a reader device when scanning the lost item (e.g., which is an approximate location of the lost item) from the lost and found server.

In some aspects, for the systems and techniques, more than hundreds of trillions of unique items associated with electronic tags (e.g., RFID tags) may be securely tracked by the lost and found system. The items may be tracked globally or on an on-premise basis. The lost and found system can add privacy, for example, when using a camera or for an indoor location. In one or more examples, the lost and found system can add new data to a lost and found database, allow for access to the data, provide a probability of a false detection of an electronic tag, and provide a number of dynamic electronic TIDs. The lost and found service can be limited to use by lost and found attested reader devices.

For product registration and onboarding, a secret key can be shared between an electronic tag (e.g., an RFID tag) and a lost and found server, an electronic tag and an owner device, and/or an electronic tag and a reader device (e.g., an attested reader device). In one or more examples, private information (e.g., a private EPC (pEPC)) can be generated based on a secret key and/or a public key. The key may be a 128 bit key. The reader devices may be attested to ensure reader device integrity and location privacy (e.g., using encryption of the reader device locations). The reader devices may have secure data paths with the lost and found server for transferring of data (e.g., encrypted reader device locations). A randomized pEPC of the items associated with the electronic tags can provide for security and privacy. A non-static pEPC can be rotated, for up to a 128 bit identification (ID). In some cases, the pEPC can have a 96 bit ID (e.g., for a lower cost). In one or more examples, the reader devices may be a RAIN RFID tag compliant. In some examples, the electronic tags (e.g., RFID tags) may have a programmable EPC (e.g., of 96, 128, or 256 bits) and a rotating encryption hardware feature.

FIG. 5 shows an example electronic tag tracking system. In particular, FIG. 5 is a diagram of an example of a system 500 for tracking items associated with passive devices (e.g., including passive device 550). In FIG. 5, the system 500 is shown to include one or more servers 510 (e.g., an application server, such as a lost and found server, for example a cloud server), one or more controllers 520 (e.g., an electronic tag controller), one or more clearing houses 530, a reader device 540, and a passive device 550 (e.g., an electronic tag, such as a RFID tag, associated with an item).

In one or more examples, during operation of the system 500 of FIG. 5, the reader device 540 (e.g., a mobile device, such as a mobile phone) can send an energizing signal 560 towards the passive device 550. The passive device 550, based on receiving the energizing signal 560, can backscatter a signal (e.g., transmit a backscattered signal) including information 570 (e.g., tag information) towards the reader device 540. In one or more examples, the information 570 may include a private EPC (pEPC) (e.g., an EPC protected by a provisioned credential) associated with the item associated with the passive device 550. In some examples, the information 570 may also include other additional information.

The reader device 540 can receive the backscattered signal with the information 570 associated with the passive device 550. The reader device 540 can then determine (e.g., generate) enrichment data (e.g., a GNSS location for the reader device 540, neighbor cell IDs, and/or sensor data) based on the backscattered signal and/or the information 570. The reader device 540 can report the information 570 and the enrichment data to the controller 520 by sending a signal 580 including the information 570 and the enrichment data to the controller 520.

The controller 520 can receive, from the reader device 540, the signal 580 including the information 570 and the enrichment data. The controller 520 can also receive, from other reader devices within the system 500, information and enrichment data related to the passive device 550 as well as other passive devices within the system 500. The controller 520 can verify the enrichment data from the reader device 540. The controller 520 can determine (e.g., generate), based on all of the received information (e.g., including information 570) and the enrichment data from all of the passive devices (e.g. including the passive device 550) in the system 500, service data (e.g., an estimated location of the passive device 550 and/or other passive devices within the system 500). In one or more examples, the controller 520 can determine an estimated location of the passive device 550 by performing triangulation using service data from multiple reader devices (e.g., including the reader device 540) in the system 500.

The controller device 520 can report the information 570 and the service data to the controller 520 by sending a signal 590 including the information 570 and the service data to the controller 520. In one or more examples, the controller device 520 can send the signal 590 to the server 510 via the clearing house 530. The server 510 can receive, from the controller 520, the signal 590 including the information 570 and the service data. In one or more examples, the server 510 can also receive information and service data from other controllers within the system 500. The server 510, based on the received information and service data, can track and locate the item associated with the passive device 550.

FIG. 6 shows an example lost and found system. In particular, FIG. 6 is a diagram of an example of a system 600 for a lost and found service for locating a lost item associated with a passive device 620. In FIG. 6, the system 600 is shown to include a lost and found secure system 610, a passive device 620 (e.g., an electronic tag, such as an RFID tag, associated with an item), and an owner device (e.g., a network device, such as a mobile device, for example a mobile phone) associated with a user (e.g., an owner) of the item. The lost and found secure system 610 is shown to include a server (e.g., a lost and found server, such as a cloud server, that may run a lost and found application) and a reader device 640 (e.g., an energizing device, which may be an owner device).

In one or more examples, during the manufacturing of the passive device 620, a secret key (K) 660 may be provisioned onto the passive device 620. In some examples, when a user (e.g., owner) associated with the owner device 630 purchases the item associated with the passive device 620, the passive device 620 can provide (e.g., share) the secret key (K) 660 to the owner device 630. The owner device 630 may generate, based on the secret key (K) 660, a public key (PK) such that the secret key (K) 660 and the public key (PK) form an ephemeral private key/public key pair.

During operation of the system 600 of FIG. 6, during onboarding 615, the owner device 630 can be onboarded with the passive device 620. Onboarding 615 is a procedure during which the secret key 660 is shared between the passive device 620 and the owner device 660, where the owner device has a sole privilege to control the passive device 620 based on the secret key. The onboarding 615 procedure can be performed in various ways. In one example, the owner device 630 can obtain (e.g., read) the secret key of the passive device 620 based on the onboarding protocol and/or by retrieving the key from the passive device manufacture. In another example, the owner device 630 and the passive device 620 can run a protocol to agree on the secret key. In another example, the owner device 630 can install the secret key to the passive device 620 based on provisioning protocol.

After the onboarding 615, the passive device 620 may generate private information by applying a cryptographic algorithm to information using (e.g., based on) the secret key (K) 660. In one or more examples, the cryptographic algorithm may be an advanced encryption standard cipher-based message authentication code (AES-CMAC) algorithm, which is a cryptographic algorithm for integrity protection (e.g., for generating an MAC). The AES-CMAC algorithm can be used by the systems and techniques described herein for generating private information, such as a private identification number or an authentication code based on AES. In one or more examples, the information can be associated with the passive device 620 (e.g., a TID of the passive device) and associated with the item (e.g., an EPC of the item). In one or more examples, the information can include a TID of the passive device 620 and an EPC of the item associated with the passive device 620. In some examples, the information can also include a timer value or a counter value associated with a time of generating the private information. In one or more examples, the private information can include a private EPC (pEPC) for the item associated with the passive device 620 and include the timer value or counter value associated with the time of generating the private information. For example, the private information can be generated by AES-CMAC(K, input), wherein the input can include the EPC, TID, and the timer or counter value. In one or more examples, the private information may be truncated to conform to the electronic tag (e.g., RFID tag) protocol. The passive device 620 may send (e.g., transmit) the passive information to the owner device 630.

The owner device 630 can register, with the server 650, the item associated with the passive device 620 for lost and found services. During the registration 620 of the item associated with the passive device 620, the owner device 630 can register, with the server 650, the private information (e.g., including the pEPC and the timer or counter value) along with the public key (PK) associated with the secret key (K) (e.g., by providing the private information and the public key (PK) to the server 650).

The reader device 640 can send an energizing signal 635 towards the passive device 620. The passive device 620, based on receiving the energizing signal 635, can transmit a backscatter signal 645 towards the reader device 640. In one or more examples, the backscatter signal 645 can include the private information (e.g., including the pEPC). The reader device 640 can receive the backscatter signal 645. The reader device 640 can determine a location of the reader device 640. In one or more examples, the reader device 640 may determine the location of the reader device 640 based on receiving one or more signals from one or more satellites associated with one or more GNSS systems. The reader device 640 can associate the backscatter signal 645 with the location of the reader device 640.

The reader device 640 can send (e.g., via signal 655) the private information (e.g., including the pEPC) to the server 650. The reader device 640 can validate, with the server 650, that the private information is registered with the passive device 620. In one or more examples, the server can validate that the private information is registered with the passive device 620 by looking up, in a lookup table including a listing of pEPCs for the registered passive devices along with their associated private information (e.g., a tag identifier (TID), which is a tag specific permanent ID, for each passive device). The validating, by the server 650, that the private information is registered with a passive device (e.g., the passive device 620) can limit or mitigate malicious reporting by reader devices of passive devices. The server 650 can then lookup, within a registration database associated with the server 650, the public key (PK) associated with the pEPC of the passive device 620.

After the server 650 has validated that the private information is registered with the passive device 620, the server 650 can send (e.g., via signal 665) the private information along with the public key (PK) to the reader device 640. The reader device 640 can encrypt, based on the public key (PK), the determined location of the reader device 640 to generate an encrypted location for the reader device 640 (e.g., Encₚₖ(loc)). Since the location of the reader device 640 is associated with the backscatter signal 645, it follows that the encrypted location of the reader device 640 is also associated with the backscatter signal 645. The use of the public key (PK) for encryption can allow for owner controlled privacy against the cloud server 650, where only the owner device 630 can decrypt (e.g., by using the secret key (K) 660) the encrypted location of the reader device 640. The reader device 640 can then send (e.g., via signal 670) the encrypted location of the reader device 640 to the server 650. For reader device 640 privacy, the owner device 630 does not know the identification of the reader device 640.

The server 650 can receive the encrypted location of the reader device 640. The server 650 can send (e.g., via signal 675) the encrypted location of the reader device 640 to the owner device 630. The owner device 630 can receive, from the server 650, the encrypted location of the reader device 640. The owner device 630 can decrypt, based on the secret key (K) 660, the encrypted location of the reader device 640 to determine the location of the reader device 640. The owner device 630 can determine, based on the location of the reader device 640, an estimated location of the item associated with the passive device 620 for locating the item. In one or more examples, the passive device 620 can be assumed to be located nearby the reader device 640 because the reader device 640 was located close enough to the passive device 620 to be able to energize the passive device 620.

In one or more aspects, the reader device 640 may use an elliptic curve cryptography (ECC) algorithm (e.g., based on the public key (PK)) to encrypt the location of the reader device 640 to generate the encrypted location of the reader device 640. The encryption of the location of the reader device 640 can allow for privacy of the reader device 640 from the server 650. In one or more examples, 128 bits of security can be assumed, wherein the public key (PK) may be 256 bits.

As mentioned, the owner device 630 can generate the public key (PK)/secret key (K) pair, and can associate the key pair with the private information (e.g., including the pEPC). In some cases, a malicious server may be able to obtain the location of the reader device 640 by using its own falsely generated key pair (e.g., a false key pair). In order to avoid a malicious server from obtaining the location of the reader device 640, a token can be used to verify that the public key (PK) is correctly associated with the passive device 620. The use of the token can provide privacy for the location of the reader device 640.

In some cases, the owner device 630 can generate the token based on the public key and the secret key K shared with the passive device (e.g., by using an algorithm, such as AES-CMAC). The token can only be generated and verified by a device (e.g., the passive device 620 and the owner device 630) that knows the secret key (K). The owner device 630 can send the token along with the public key (PK) to the server 650. The server 650 can send the public key (PK) along with the token to the reader device 640. The reader device 640 can send the public key (PK) along with the token to the passive device 620 for verification. The passive device 620 can confirm to the reader device 640 that the public key (PK) is correctly associated with the passive device 620 by verifying (e.g., by using the algorithm, such as AES-CMAC, based on the secret key (K)) the token. After the passive device 620 performs the verification, the passive device 620 can notify the reader device 640 that the public key (PK) is correctly associated with the passive device 620.

In one or more aspects, if the passive device 620 (e.g., an electronic tag) can perform point multiplication, which is needed for ECC, token generation is not needed to verify that the public key (PK) is correctly associated with the passive device 620. For these cases, the passive device 620 can generate a private key (SK) (e.g., by using an encryption algorithm based on the secret key (K) 660) and then the corresponding public key (PK) that is associated with the passive device. In one or more examples, the information can include a TID of the passive device 620, an EPC of the item associated with the passive device 620, and a timer value or a counter value associated with a time of generating the private key (SK). The algorithm can be an AES-based algorithm (e.g., AES-CMAC) that outputs a 256 bit value. The passive device 620 can, by performing point multiplication, calculate the public key (PK) to be equal to the generated private key (SK) multiplied by G, where G is a point on an elliptic curve and a public parameter.

The passive device 620 can send the calculated public key (PK) to the reader device 640. In one or more examples, the reader may validate the PK received from the server by sending PK verification request to the passive device. The passive device 620 can verify the PK by generating the PK from the SK. The passive device 620 can generate private information (e.g., including pEPC′). In one or more examples, the algorithm can be an AES-based algorithm (e.g., AES-CMAC).

The reader device 640 can send the private information (e.g., including pEPC′) to the passive device 620 for verification. The passive device 620 can verify that the public key (PK) is correctly associated with the passive device 620 by decrypting (e.g., by using the algorithm, such as AES-CMAC, based on the secret key (K)) the private information to generate the public key (PK). After the passive device 620 performs the verification, the passive device 620 can notify the reader device 640 that the public key (PK) is correctly associated with the passive device 620. In one or more examples, a stronger level of security can be provided if the passive device 620 can utilize a cryptographic hash function, instead of an AES-CMAC algorithm, for the encryption and decryption operations.

In one or more aspects, a timer may be employed within the passive device 620 to mitigate denial of service (DoS) and/or encryption oracle attacks. In one or more examples, a low complexity timer may be employed in the passive device 620. In some examples, the maximum expiration time for the timer can be dependent upon the passive device 620 (e.g., electronic tag) and/or service.

Once the passive device 620 is energized by the energizing signal 635 from the reader device 640, the timer of the passive device 620 can start. In one or more examples, when the timer is implemented within the passive device 620 by a capacitor, the timer can expire when the capacitor has been fully depleted (e.g., fully discharged). In some examples, the timer will not reset until the timer has expired.

When the timer is started (or restarted after expiration), a private information flag may be set (or reset). The setting of the private information flag can indicate that a new generation of the private information (e.g., including pEPC) is needed. In one or more examples, when the private information flag is set (or reset), a new generation of the private information (e.g., including pEPC) will be performed (e.g., by the passive device 620). Once the new private information is generated, the private information flag will be reset. As such, no new generation of the private information will be performed, until the timer expires.

In one or more examples, the private information generation may employ a counter, instead of a timer. If the private information generation utilizes a counter, the counter value can be updated (e.g., incremented by one) upon generation of the new private information.

In some examples, even if the passive device 620 is continuously being interrogated (e.g., energized) by devices (e.g., by attackers), the passive device 620 will not generate new private information (and will not update its state, such as update the private information flag) until the timer has expired. In one or more examples, the timer may be used to limit the minimum interrogation response interval, which may reduce potential tracking by attackers.

In one or more examples, the server 650 may need to keep track of the multiple different versions of the private information for a single passive device (e.g., passive device 620) to address any potential error scenarios where the passive device has not be energized for a long time (e.g., due to the passive device being located out of communication range of a reader device, or due to the private information not being reported to the server 650 due to communication errors, a DoS attack, or jamming).

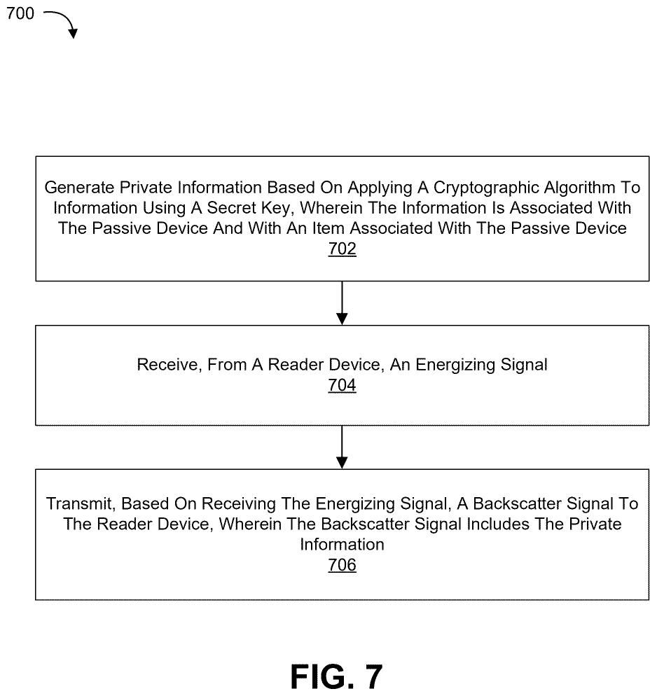

FIG. 7 is a flow chart illustrating an example of a process 700 for wireless communications at a passive device. The process 700 can be performed by a computing device (e.g., a passive device, such as an RFID tag, the RF energy harvesting device 200 of FIG. 2, the passive device 550 of FIG. 5, the passive device 620 of FIG. 6, a computing device or computing system 900 of FIG. 9, etc.) or by a component or system (e.g., a processing system, a chipset, one or more processors such as one or more central processing units (CPUs), one or more digital signal processors (DSPs), one or more graphics processing units (GPUs), and/or other type of processor(s), any combination thereof, and/or other component or system) of the computing device. The operations of the process 700 may be implemented as software components that are executed and run on one or more processors (e.g., processing system 910 of FIG. 9, or other processor(s)). Further, the transmission and reception of signals by the computing device in the process 700 may be enabled, for example, by one or more antennas and/or one or more transceivers (e.g., wireless transceiver(s)).

At block 702, the computing device (or component thereof) can generate private information based on application of a cryptographic algorithm to information using a secret key. The information is associated with the computing device and with an item associated with the computing device. In some aspects, the information includes an electronic product code (EPC) associated with the item and a tag identification (TID) associated with the computing device. Additionally or alternatively, in some cases, the information includes a timer value or a counter value associated with a time of generating of the private information. In some aspects, the cryptographic algorithm is an advanced encryption standard cipher-based message authentication code (AES-CMAC) algorithm or other type of algorithm.

At block 704, the computing device (or component thereof) can receive, from a reader device (e.g., reader device 540 of FIG. 5, reader device 640 of FIG. 6, etc.), an energizing signal. In some aspects, the computing device (or component thereof) can initiate a timer associated with the computing device based on receiving the energizing signal from the reader device. In some cases, the computing device (or component thereof) can generate the private information upon expiration of the timer. In some examples, the timer expires when a charge of a capacitor of the computing device has been fully depleted. In some aspects, the computing device (or component thereof) can set, based on expiration of the timer, a private information flag to indicate to the computing device to generate the private information.

At block 706, the computing device (or component thereof) can transmit (or output for transmission), based on receiving the energizing signal, a backscatter signal to the reader device, where the backscatter signal includes the private information. In some aspects, the reader device can validate, with a server, that the private information is registered with the computing device. The reader device can determine a location of the reader device. The reader device can encrypt the location based on a public key associated with the secret key to generate an encrypted location. The reader device can send the encrypted location to the server.

In some aspects, the computing device (or component thereof) can provide the secret key to a network device (e.g., the owner device 630 of FIG. 6). In some aspects, the network device can receive the encrypted location from the server. The network device can decrypt the encrypted location based on the secret key to generate the location of the reader device. The network device can determine an estimated location of the item based on the location of the reader device.

In some aspects, the computing device (or component thereof) can receive, from the reader device, a token. For example, the network device (e.g., the owner device 630 of FIG. 6) can generate the token based on encryption of a public key and the secret key. The computing device (or component thereof) can verify the public key is associated with the computing device by decrypting, based on the secret key, the token to generate the public key.

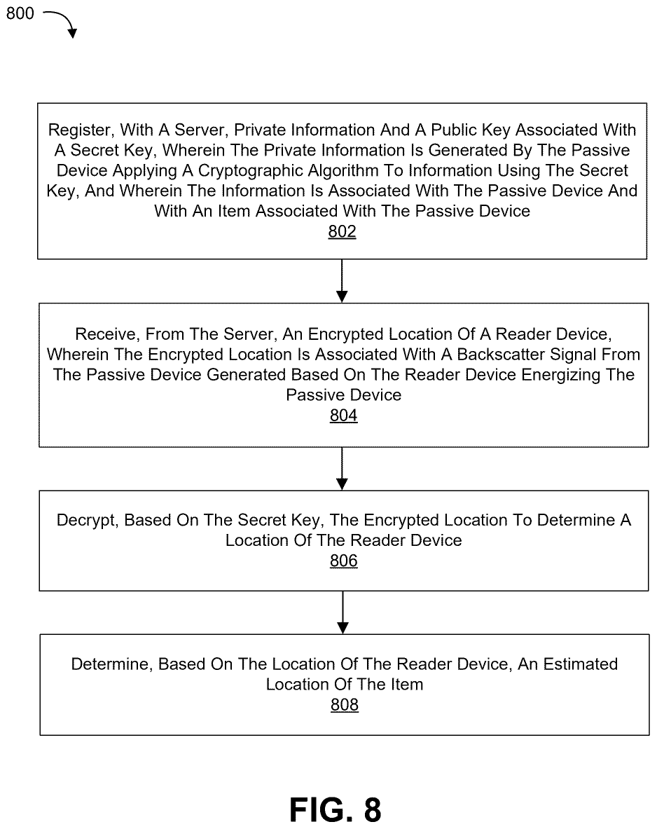

FIG. 8 is a flow chart illustrating an example of a process 800 for wireless communications at a network device. The process 800 can be performed by a computing device (e.g., a network device, such as the wireless device 107 of FIG. 1, the owner device 630 of FIG. 6, or a computing device or computing system 900 of FIG. 9) or by a component or system (e.g., a processing system, a chipset, one or more processors such as one or more central processing units (CPUs), one or more digital signal processors (DSPs), one or more graphics processing units (GPUs), and/or other type of processor(s), any combination thereof, and/or other component or system) of the computing device. The operations of the process 800 may be implemented as software components that are executed and run on one or more processors (e.g., processing system 910 of FIG. 9, or other processor(s)). Further, the transmission and reception of signals by the computing device in the process 800 may be enabled, for example, by one or more antennas and/or one or more transceivers (e.g., wireless transceiver(s)).

At block 802, the computing device (or component thereof) can register, with a server, private information and a public key associated with a secret key. The private information is generated by a passive device (e.g., an RFID tag or other device) applying a cryptographic algorithm to information using the secret key. The information is associated with the passive device and with an item associated with the passive device.

At block 804, the computing device (or component thereof) can receive, from the server, an encrypted location of a reader device. The encrypted location is associated with a backscatter signal from the passive device generated based on the reader device energizing the passive device. In some aspects, the encrypted location of the reader device is generated based on an elliptic curve cryptography (ECC) algorithm.

At block 806, the computing device (or component thereof) can decrypt, based on the secret key, the encrypted location to determine a location of the reader device.

At block 808, the computing device (or component thereof) can determine, based on the location of the reader device, an estimated location of the item.

In some aspects, the computing device (or component thereof) can encrypt, based on the secret key, the public key to generate a token for verifying the public key is associated with the passive device. In some cases, the computing device (or component thereof) can transmit (or output for transmission) the token to the server. In some aspects, the passive device verifies the public key is associated with the passive device based on decryption of the token based on the secret key to generate the public key.

In some cases, the computing device of process 700 and process 800 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 700 and process 800 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 700 and process 800 is each illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 700 and process 800 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a block diagram illustrating an example of a computing system 900, which may be employed for a lost and found service for a passive device, such as a low complexity RFID tag. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processing system 910, such as in a chipset architecture. Connection 905 can also be a virtual connection, networked connection, or logical connection.

In some aspects, computing system 900 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 900 includes at least one processing unit (CPU or processor) 910 and connection 905 that communicatively couples various system components including system memory 915, such as read-only memory (ROM) 920 and random access memory (RAM) 925 to processing system 910. Computing system 900 can include a cache 912 of high-speed memory connected directly with, in close proximity to, or integrated as part of processing system 910.

Processing system 910 can include any general purpose processor and a hardware service or software service, such as services 932, 934, and 936 stored in storage device 930, configured to control processing system 910 as well as a special-purpose processor where software instructions are incorporated into the actual processor design. Processing system 910 may essentially be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, etc. Computing system 900 can also include output device 935, which can be one or more of a number of output mechanisms. In some instances, multimodal systems can enable a user to provide multiple types of input/output to communicate with computing system 900.

Computing system 900 can include communications interface 940, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 940 may also include one or more range sensors (e.g., LiDAR sensors, laser range finders, RF radars, ultrasonic sensors, and infrared (IR) sensors) configured to collect data and provide measurements to processing system 910, whereby processing system 910 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 940 may also include one or more backscattered signal with the tag information 570 receivers or transceivers that are used to determine a location of the computing system 900 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processing system 910, it causes the system to perform a function. In some aspects, a hardware service that performs a particular function can include the software component stored in a computer-readable medium in connection with the necessary hardware components, such as processing system 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“<”) and greater than or equal to (“>”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for wireless communications, the apparatus comprising: a processing system configured to: generate private information based on application of a cryptographic algorithm to information using a secret key, wherein the information is associated with the apparatus and with an item associated with the apparatus; receive, from a reader device, an energizing signal; and output, based on receiving the energizing signal, a backscatter signal for transmission to the reader device, wherein the backscatter signal comprises the private information.

Aspect 2. The apparatus of Aspect 1, wherein the reader device validates, with a server, that the private information is registered with the apparatus, determines a location of the reader device, encrypts the location based on a public key associated with the secret key to generate an encrypted location, and sends the encrypted location to the server.

Aspect 3. The apparatus of Aspect 2, further comprising providing the secret key to a network device.

Aspect 4. The apparatus of Aspect 3, wherein the network device receives the encrypted location from the server, decrypts the encrypted location based on the secret key to generate the location of the reader device, and determines an estimated location of the item based on the location of the reader device.

Aspect 5. The apparatus of any of Aspects 1 to 4, wherein the information comprises an electronic product code (EPC) associated with the item and a tag identification (TID) associated with the apparatus.

Aspect 6. The apparatus of Aspect 5, wherein the information further comprises a timer value or a counter value associated with a time of generating of the private information.

Aspect 7. The apparatus of any of Aspects 1 to 6, wherein the cryptographic algorithm is an advanced encryption standard cipher-based message authentication code (AES-CMAC) algorithm.

Aspect 8. The apparatus of any of Aspects 1 to 7, wherein the processing system is configured to: receive, from the reader device, a token, wherein the token is generated based on encryption of a public key by a network device based on the secret key; and verify the public key is associated with the apparatus by decrypting, based on the secret key, the token to generate the public key.

Aspect 9. The apparatus of any of Aspects 1 to 8, wherein the processing system is configured to initiate a timer associated with the apparatus based on receiving the energizing signal from the reader device.

Aspect 10. The apparatus of Aspect 9, wherein the processing system is configured to generate the private information upon expiration of the timer.

Aspect 11. The apparatus of any of Aspects 9 or 10, wherein the timer expires when a charge of a capacitor of the apparatus has been fully depleted.

Aspect 12. The apparatus of any of Aspects 9 to 11, wherein the processing system is configured to set, based on expiration of the timer, a private information flag to indicate to the apparatus to generate the private information.

Aspect 13. The apparatus of any of Aspects 1 to 12, wherein the apparatus is a passive device.

Aspect 14. The apparatus of Aspect 13, wherein the passive device is a radio frequency identification (RFID) tag.

Aspect 15. A network device for wireless communications, the network device comprising: a processing system configured to: register, with a server, private information and a public key associated with a secret key, wherein the private information is generated by a passive device applying a cryptographic algorithm to information using the secret key, and wherein the information is associated with the passive device and with an item associated with the passive device; receive, from the server, an encrypted location of a reader device, wherein the encrypted location is associated with a backscatter signal from the passive device generated based on the reader device energizing the passive device; decrypt, based on the secret key, the encrypted location to determine a location of the reader device; and determine, based on the location of the reader device, an estimated location of the item.

Aspect 16. The network device of Aspect 15, wherein the processing system configured to encrypt, based on the secret key, the public key to generate a token for verifying the public key is associated with the passive device.

Aspect 17. The network device of Aspect 16, wherein the processing system configured to output the token for transmission to the server.

Aspect 18. The network device of any of Aspects 16 or 17, wherein the passive device verifies the public key is associated with the passive device based on decryption of the token based on the secret key to generate the public key.

Aspect 19. The network device of any of Aspects 15 to 18, wherein the encrypted location of the reader device is generated based on an elliptic curve cryptography (ECC) algorithm.

Aspect 20. The network device of any of Aspects 15 to 19, wherein the passive device is a radio frequency identification (RFID) tag.

Aspect 21. A method for wireless communications performed at a passive device, the method comprising: generating private information based on applying a cryptographic algorithm to information using a secret key, wherein the information is associated with the passive device and with an item associated with the passive device; receiving, from a reader device, an energizing signal; and transmitting, based on receiving the energizing signal, a backscatter signal to the reader device, wherein the backscatter signal comprises the private information.

Aspect 22. The method of Aspect 21, wherein the reader device validates, with a server, that the private information is registered with the passive device, determines a location of the reader device, encrypts the location based on a public key associated with the secret key to generate an encrypted location, and sends the encrypted location to the server.

Aspect 23. The method of Aspect 22, further comprising providing the secret key to a network device.

Aspect 24. The method of Aspect 23, wherein the network device receives the encrypted location from the server, decrypts the encrypted location based on the secret key to generate the location of the reader device, and determines an estimated location of the item based on the location of the reader device.

Aspect 25. The method of any of Aspects 21 to 24, wherein the private information comprises an electronic product code (EPC) associated with the item and a tag identification (TID) associated with the passive device.

Aspect 26. The method of Aspect 25, wherein the private information further comprises a timer value or a counter value associated with a time of generating of the private information.

Aspect 27. The method of any of Aspects 21 to 26, wherein the cryptographic algorithm is an advanced encryption standard cipher-based message authentication code (AES-CMAC) algorithm.

Aspect 28. The method of any of Aspects 21 to 27, further comprising: receiving, from the reader device, a token, wherein the token is generated based on encryption of a public key by a network device based on the secret key; and verifying the public key is associated with the passive device by decrypting, based on the secret key, the token to generate the public key.

Aspect 29. The method of any of Aspects 21 to 28, further comprising initiating a timer associated with the passive device based on receiving the energizing signal from the reader device.

Aspect 30. The method of Aspect 29, further comprising generating the private information upon expiration of the timer.

Aspect 31. The method of any of Aspects 29 or 30, wherein the timer expires when a charge of a capacitor of the passive device has been fully depleted.

Aspect 32. The method of any of Aspects 29 to 31, further comprising setting, based on expiration of the timer, a private information flag to indicate to the passive device to generate the private information.

Aspect 33. The method of any of Aspects 21 to 32, wherein the passive device is a radio frequency identification (RFID) tag.

Aspect 34. A method for wireless communications performed at a network device, the method comprising: registering, with a server, private information and a public key associated with a secret key, wherein the private information is generated by a passive device applying a cryptographic algorithm to information using the secret key, and wherein the information is associated with the passive device and with an item associated with the passive device; receiving, from the server, an encrypted location of a reader device, wherein the encrypted location is associated with a backscatter signal from the passive device generated based on the reader device energizing the passive device; decrypting, based on the secret key, the encrypted location to determine a location of the reader device; and determining, based on the location of the reader device, an estimated location of the item.

Aspect 35. The method of Aspect 34, further comprising encrypting, based on the secret key, the public key to generate a token for verifying the public key is associated with the passive device.

Aspect 36. The method of Aspect 35, further comprising transmitting the token to the server.

Aspect 37. The method of any of Aspects 35 or 36, wherein the passive device verifies the public key is associated with the passive device based on decryption of the token based on the secret key to generate the public key.

Aspect 38. The method of any of Aspects 34 to 37, wherein the encrypted location of the reader device is generated based on an elliptic curve cryptography (ECC) algorithm.

Aspect 39. The method of any of Aspects 34 to 38, wherein the passive device is a radio frequency identification (RFID) tag.

Aspect 40. A non-transitory computer-readable medium having stored thereon instructions that, when executed by at least one processor, cause the at least one processor to perform operations according to any of Aspects 21 to 33.

Aspect 41. An apparatus for wireless communications, the apparatus including one or more means for performing operations according to any of Aspects 21 to 33.

Aspect 42. A non-transitory computer-readable medium having stored thereon instructions that, when executed by at least one processor, cause the at least one processor to perform operations according to any of Aspects 34 to 39.

Aspect 43. An apparatus for wireless communications, the apparatus including one or more means for performing operations according to any of Aspects 34 to 39.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for wireless communications, the apparatus comprising:
a processing system configured to:
generate private information based on application of a cryptographic algorithm to information using a secret key, wherein the information is associated with the apparatus and with an item associated with the apparatus;
receive, from a reader device, an energizing signal; and
output, based on receiving the energizing signal, a backscatter signal for transmission to the reader device, wherein the backscatter signal comprises the private information.

2. The apparatus of claim 1, wherein the reader device validates, with a server, that the private information is registered with the apparatus, determines a location of the reader device, encrypts the location based on a public key associated with the secret key to generate an encrypted location, and sends the encrypted location to the server.

3. The apparatus of claim 2, further comprising providing the secret key to a network device.

4. The apparatus of claim 3, wherein the network device receives the encrypted location from the server, decrypts the encrypted location based on the secret key to generate the location of the reader device, and determines an estimated location of the item based on the location of the reader device.

5. The apparatus of claim 1, wherein the information comprises an electronic product code (EPC) associated with the item and a tag identification (TID) associated with the apparatus.

6. The apparatus of claim 5, wherein the information further comprises a timer value or a counter value associated with a time of generating of the private information.

7. The apparatus of claim 1, wherein the cryptographic algorithm is an advanced encryption standard cipher-based message authentication code (AES-CMAC) algorithm.

8. The apparatus of claim 1, wherein the processing system is configured to:
receive, from the reader device, a token, wherein the token is generated based on encryption of a public key by a network device based on the secret key; and
verify the public key is associated with the apparatus by decrypting, based on the secret key, the token to generate the public key.

9. The apparatus of claim 1, wherein the processing system is configured to initiate a timer associated with the apparatus based on receiving the energizing signal from the reader device.

10. The apparatus of claim 9, wherein the processing system is configured to generate the private information upon expiration of the timer.

11. The apparatus of claim 9, wherein the timer expires when a charge of a capacitor of the apparatus has been fully depleted.

12. The apparatus of claim 9, wherein the processing system is configured to set, based on expiration of the timer, a private information flag to indicate to the apparatus to generate the private information.

13. The apparatus of claim 1, wherein the apparatus is a radio frequency identification (RFID) tag.

14. A network device for wireless communications, the network device comprising:
a processing system configured to:
register, with a server, private information and a public key associated with a secret key, wherein the private information is generated by a passive device applying a cryptographic algorithm to information using the secret key, and wherein the information is associated with the passive device and with an item associated with the passive device;
receive, from the server, an encrypted location of a reader device, wherein the encrypted location is associated with a backscatter signal from the passive device generated based on the reader device energizing the passive device;
decrypt, based on the secret key, the encrypted location to determine a location of the reader device; and
determine, based on the location of the reader device, an estimated location of the item.

15. The network device of claim 14, wherein the processing system configured to encrypt, based on the secret key, the public key to generate a token for verifying the public key is associated with the passive device.

16. The network device of claim 15, wherein the processing system configured to output the token for transmission to the server.

17. The network device of claim 15, wherein the passive device verifies the public key is associated with the passive device based on decryption of the token based on the secret key to generate the public key.

18. The network device of claim 14, wherein the encrypted location of the reader device is generated based on an elliptic curve cryptography (ECC) algorithm.

19. The network device of claim 14, wherein the passive device is a radio frequency identification (RFID) tag.

20. A method for wireless communications performed at a passive device, the method comprising:
generating private information based on applying a cryptographic algorithm to information using a secret key, wherein the information is associated with the passive device and with an item associated with the passive device;
receiving, from a reader device, an energizing signal; and
transmitting, based on receiving the energizing signal, a backscatter signal to the reader device, wherein the backscatter signal comprises the private information.
